(19) United States
(12) Patent Application Publication
(10) Pub. No.: US 2026/0004395 A1
(43) Pub. Date: Jan. 1, 2026

(54) PANORAMIC VIDEO PROCESSING METHOD, SYSTEM, DEVICE, COMPUTER DEVICE, AND MEDIUM

(71) Applicant: ARASHI VISION INC., Shenzhen (CN)

(72) Inventors: Weihan LING, Shenzhen (CN); Guo WANG, Shenzhen (CN); Li ZHU, Shenzhen (CN); Xiaoyan ZHANG, Shenzhen (CN)

(73) Assignee: ARASHI VISION INC., Shenzhen (CN)

(21) Appl. No.: 19/253,628

(22) Filed: Jun. 27, 2025

(30) Foreign Application Priority Data
Jun. 28, 2024 (CN) 202410861549.3

(51) Int. Cl. G06T 3/4038; G06F 3/01; H04N 19/136

(52) U.S. Cl. CPC G06T 3/4038; G06F 3/013; H04N 19/136

(57) ABSTRACT

In some aspects of the present disclosure, a processing method for a panoramic video is provided. A current viewing region of a user is determined, and a corresponding target video stream can be acquired based on the viewing region. The target video stream can be decoded and rendered to the viewing region. In respect to detecting that the viewing region of the user changes, a new target video stream corresponding to the changed viewing region can be determined, and a background bitstream can be displayed during a process of switching to the new target video stream. The background bitstream may include a low-resolution bitstream of the panoramic video.

### CROSS-REFERENCE TO RELATED APPLICATION

This application claims the benefit of priority to Chinese Patent Application No. 202410861549.3, filed on Jun. 28, 2024, the entire content of which is hereby incorporated by reference in its entirety.

### BACKGROUND

The present disclosure relates to the technical field of video processing, and in particular, to a panoramic video processing method, system, device, computer device, and medium.

A panoramic video is a type of video captured in all directions at 360 degrees using a panoramic camera, allowing users to freely adjust the viewing direction while watching the video. As panoramic video is required to cover 360 degrees of content, the bitrate of a complete panoramic video is generally very high.

### SUMMARY

Based on this, it is necessary to provide a panoramic video processing method, system, device, computer device, and medium that can ensure efficient transmission under low bandwidth to address the above technical problems.

In a first aspect, the present disclosure provides a panoramic video processing method, applied to a client, the method including:
determining a current viewing region of a user, and acquiring a corresponding target video stream based on the viewing region;
decoding and rendering the target video stream to the viewing region; and
when it is detected that the viewing region of the user changes, determining a new target video stream corresponding to the changed viewing region, and displaying a background bitstream during a process of switching to the new target video stream, where the background bitstream is a low-resolution bitstream of the panoramic video.

In one implementation, the method further includes:
when it is detected that a display cannot normally display the target video stream, displaying the background bitstream.

In one implementation, when it is detected that a display cannot normally display the target video stream, displaying the background bitstream includes:
when the target video stream cannot be pulled from a server in time, displaying the background bitstream on the display.

In one implementation, determining a current viewing region of a user, and acquiring a corresponding target video stream based on the viewing region includes:
determining a current viewing region of a user, and determining a corresponding video slice index based on the viewing region, where the video slice index is an index of a slice video in the panoramic video;
acquiring a corresponding slice video stream based on the video slice index, where the slice video stream is the target video stream; and
when it is detected that the viewing region of the user changes, determining a new target video stream corresponding to the changed viewing region, and displaying a background bitstream during a process of switching to the new target video stream, where the background bitstream is a low-resolution bitstream of the panoramic video includes:
when it is detected that the viewing region of the user changes, determining a new video slice index corresponding to the changed viewing region, pulling a corresponding new slice video stream based on the new video slice index, and displaying the background bitstream during a process of switching to the new slice video stream.

In one implementation, acquiring a corresponding slice video stream based on the video slice index includes:
sending the video slice index to a server, so that the server determines a slice video stream to be sent based on the video slice index; and
receiving the slice video stream sent by the server.

In one implementation, different resolution slice videos are stored on the server for the same slice. The video slice index includes a layer index and a slice index of the same layer, wherein each layer corresponds to a distinct resolution, and slices within a same layer share a same resolution.

In one implementation, different resolution slice videos are stored on the server for the same slice; and the method further includes:
determining a size of a field of view angle corresponding to the viewing region;
determining a corresponding target resolution based on the size of the field of view angle and/or a current network bandwidth condition of the client; and
acquiring a corresponding slice video stream based on the video slice index includes:
receiving a slice video stream sent by the server based on the video slice index and the target resolution.

In one implementation, different resolution slice videos are stored on the server for the same slice, including:
the server determines a search range corresponding to each slice video;
the server performs motion search in each search range, to obtain a motion vector corresponding to each search range;
the server encodes each slice video based on the motion vector corresponding to each search range, to obtain a plurality of encoded slice videos; and
the server stores the plurality of encoded slice videos.

In one implementation, the panoramic video may include a fisheye image captured by a fisheye camera; and different resolution slice videos are stored on the server for the same slice, including:
the server maps the fisheye image to a preset unfolded image based on a mapping relationship between the fisheye image and the unfolded image;
the server performs image rendering on the preset unfolded image based on preset different resolutions, to obtain a cubic unfolded image corresponding to the different resolutions; and the server segments the cubic unfolded image based on a segmentation requirement, to obtain a plurality of slice videos.

In one implementation, different resolution slice videos are stored on the server for the same slice; and the method further includes:
determining a “size” of a field of view angle corresponding to the viewing region, and sending the size of the field of view angle to the server, so that the server determines a corresponding target resolution based on the size of the field of view angle and/or a current network bandwidth condition of the client, and determines a slice video stream to be sent based on the video slice index and the target resolution.

In one implementation, determining a corresponding video slice index based on the viewing region includes:
determining the video slice index based on a position of a projection of each pixel in the viewing region on the panoramic video.

In one implementation, determining the video slice index based on the position of the projection of each pixel in the viewing region on the panoramic video includes:
determining a rendering window based on a view angle parameter of a current rendered image corresponding to the viewing region;
determining a target pixel falling in the rendering window on a cubic unfolded image corresponding to the panoramic video; and
determining the video slice index based on the target pixel.

In one implementation, determining the target pixel falling in the rendering window on the cubic unfolded image corresponding to the panoramic video includes:
projecting each pixel in the cubic unfolded image onto a plane where the rendering window is located, to obtain a mask image corresponding to the cubic unfolded image, where a gray value of a pixel contained in the rendering window in the mask image is a first value, and a gray value of a pixel contained in another region in the mask image is a second value; and
determining the target pixel falling in the rendering window on the cubic unfolded image based on the mask image.

In one implementation, projecting each pixel in the cubic unfolded image onto the plane where the rendering window is located, to obtain the mask image corresponding to the cubic unfolded image includes:
projecting each pixel in the cubic unfolded image onto the plane where the rendering window is located, to obtain projected pixels; and
setting a gray value of a pixel located in the rendering window to the first value, and setting a gray value of another pixel to the second value, to obtain the mask image.

In one implementation, decoding and rendering the slice video stream to the viewing region includes:
merging the slice video stream to obtain a merged video stream;
decoding the merged video stream to obtain decoded frame data; and
uploading the decoded frame data to a renderer, and determining a position of each pixel in the viewing region on the decoded frame data by the renderer, to render the decoded frame data to the viewing region.

In a second aspect, the present disclosure provides a panoramic video processing method, applied to a server, the method including:
receiving a video slice index sent by a client, where the video slice index is determined based on a current viewing region of a user, and the video slice index is an index of a slice video in a panoramic video; and
sending a corresponding slice video stream and a background bitstream to the client based on the video slice index, where the background bitstream is a low-resolution bitstream of the panoramic video, so that the client displays the background bitstream during a process of switching to a new slice video stream.

In one implementation, the method further includes:
receiving an uploaded panoramic video; and
segmenting the panoramic video into a plurality of slice videos, and storing the plurality of slice videos.

In one implementation, the method further includes:
encoding each slice video to obtain a plurality of encoded slice videos; and
the storing the plurality of slice videos includes:
storing the plurality of encoded slice videos in a video database.

In one implementation, encoding each slice video to obtain a plurality of encoded slice videos includes:
determining a search range corresponding to each slice video;
performing motion search in each search range, to obtain a motion vector corresponding to each search range; and
encoding each slice video based on the motion vector corresponding to each search range, to obtain the plurality of encoded slice videos.

In one implementation, determining a search range corresponding to each slice video includes:

for each slice video, determining a search range corresponding to each coding block based on a size of the slice video and a position of the coding block in the slice video.

In one implementation, segmenting the panoramic video into a plurality of slice videos includes:
generating a corresponding cubic unfolded image based on the panoramic video; and
segmenting the cubic unfolded image based on a segmentation requirement, to obtain the plurality of slice videos.

In one implementation, the panoramic video is a fisheye image captured by a fisheye camera; and generating a corresponding cubic unfolded image based on the panoramic video includes:
mapping the fisheye image to a preset unfolded image based on a mapping relationship between the fisheye image and the unfolded image; and
performing image rendering on the preset unfolded image based on preset different resolutions, to obtain a cubic unfolded image corresponding to the different resolutions.

In one implementation, performing image rendering on the preset unfolded image based on the preset different resolutions, to obtain the cubic unfolded image corresponding to the different resolutions includes:
performing image rendering on the preset unfolded image based on a maximum resolution in the preset different resolutions, to obtain a cubic unfolded image corresponding to the maximum resolution; and
respectively performing downsampling on the unfolded image corresponding to the maximum resolution based on other resolutions in the different resolutions, to obtain a cubic unfolded image corresponding to the other resolutions.

In one implementation, the method further includes:
dividing texture features in the unfolded image into a first texture region and a second texture region, a comparison degree of the texture features in the first texture region is higher than a comparison degree of the texture features in the second texture region;
adjusting ranges of the first texture region and the second texture region in the unfolded image, to obtain a new unfolded image;
establishing a mapping relationship between the new unfolded image and the fisheye image; and
the mapping the fisheye image to the preset unfolded image based on the mapping relationship between the fisheye image and the unfolded image includes:
mapping the fisheye image to the preset unfolded image based on the mapping relationship between the new unfolded image and the fisheye image.

In one implementation, adjusting ranges of the first texture region and the second texture region in the unfolded image, to obtain a new unfolded image includes:
expanding the range of the first texture region and reducing the range of the second texture region, to obtain the new unfolded image, where a first range in the new unfolded image is equal to a second range in the unfolded image, and the first range is a sum of the ranges of the first texture region and the second texture region in the new unfolded image, and the second range is a sum of the ranges of the first texture region and the second texture region in the unfolded image.

In a third aspect, the present disclosure provides a panoramic video processing system, including: a camera end, a client, and a server;
the camera end is configured to send a captured panoramic video to the server;
the server is configured to segment the panoramic video into a plurality of slice videos, store the plurality of slice videos, and generate a video slice index corresponding to each slice video;
the server is further configured to generate a low-resolution bitstream of the panoramic video as a background bitstream based on the panoramic video;
the client is configured to determine a current viewing region of a user, determine a corresponding video slice index based on the viewing region, and send the video slice index to the server; and
the server is further configured to send a corresponding slice video stream and a background bitstream to the client based on the video slice index, so that the client displays the background bitstream during a process of switching to a new slice video stream.

In a fourth aspect, the present disclosure further provides a panoramic video processing device, applied to a client, the device including:
a first determining module, configured to determine a current viewing region of a user, and determine a corresponding video slice index based on the viewing region, where the video slice index is an index of a slice video in the panoramic video;
an acquiring module, configured to acquire a corresponding slice video stream based on the video slice index;
a decoding and rendering module, configured to decode and render the slice video stream to the viewing region; and
a second determining module, configured to, when it is detected that the viewing region of the user changes, determine a new video slice index corresponding to the changed viewing region, pull a corresponding new slice video stream based on the new video slice index, and display a background bitstream during a process of switching to the new slice video stream, where the background bitstream is a low-resolution bitstream of the panoramic video.

In a fifth aspect, the present disclosure further provides a panoramic video processing device, applied to a server, the device including:
a receiving module, configured to receive a video slice index sent by a client, the video slice index is determined based on a current viewing region of a user, and the video slice index is an index of a slice video in the panoramic video; and
a sending module, configured to send a corresponding slice video stream and a background bitstream to the client based on the video slice index, where the background bitstream is a low-resolution bitstream of the panoramic video, so that the client displays the background bitstream during a process of switching to a new slice video stream.

In a sixth aspect, the present disclosure further provides a computer device. The computer device includes a memory and a processor, the memory stores a computer program, and when the processor executes the computer program, the operations of any implementation of the method in the first aspect above can be implemented.

In a seventh aspect, the present disclosure further provides a computer-readable storage medium. The computer-readable storage medium stores a computer program, and when the computer program is executed by a processor, the operations of any implementation of the method in the first aspect above can be implemented.

In an eighth aspect, the present disclosure further provides a computer program product. The computer program product includes a computer program, and when the computer program is executed by a processor, the operations of any implementation of the method in the first aspect above can be implemented.

In the above panoramic video processing method, system, device, computer device, and medium, a current viewing region of a user is determined, and a corresponding target video stream is acquired based on the viewing region; the target video stream is decoded and rendered to the viewing region; and when it is detected that the viewing region of the user changes, a new target video stream corresponding to the changed viewing region is determined, and a background bitstream is displayed during a process of switching to the new target video stream, where the background bitstream is a low-resolution bitstream of the panoramic video. Since the user usually only watches part of the content when viewing the panoramic video, the present disclosure can process only the target video stream corresponding to the viewing region, without transmitting and processing the entire panoramic video, which can greatly reduce the network bandwidth in the transmission and processing of panoramic video, and does not affect the effect of the user watching the slice video, thereby ensuring smooth and efficient transmission and visual quality of panoramic video under low bandwidth.

### BRIEF DESCRIPTION OF DRAWINGS

In order to more clearly illustrate the technical solutions in the implementations or related technologies of the present disclosure, the drawings required for the description of the implementations or related technologies are briefly introduced below. It is obvious that the drawings described below are only some implementations of the present disclosure, and for those skilled in the art, other drawings can be obtained based on these drawings without creative work.

FIG. 1 is an application environment diagram of a panoramic video processing method, according to some aspects of the present disclosure.

FIG. 2 is a flowchart of a panoramic video processing method applied to a client, according to some aspects of the present disclosure.

FIG. 3 is a flowchart of a panoramic video processing method including an operation of acquiring a target video stream, according to some aspects of the present disclosure.

FIG. 4 is a flowchart of another panoramic video processing method, according to some aspects of the present disclosure.

FIG. 5 is a flowchart of still another panoramic video processing method, according to some aspects of the present disclosure.

FIG. 6 is a flowchart of a panoramic video processing method applied to a server, according to some aspects of the present disclosure.

FIG. 7 is a flowchart of a panoramic video processing method including an operation of segmenting a panoramic video, according to some aspects of the present disclosure.

FIG. 8 is a flowchart of a panoramic video processing method including an encoding operation, according to some aspects of the present disclosure.

FIG. 9 is a flowchart of an encoding operation, according to some aspects of the present disclosure.

FIG. 10 is a flowchart of an operation of segmenting a panoramic video, according to some aspects of the present disclosure.

FIG. 11 is a flowchart of an operation of generating a cubic unfolded image, according to some aspects of the present disclosure.

FIG. 12 is a flowchart of an operation of generating a cubic unfolded image, according to some aspects of the present disclosure.

FIG. 13 is a structural block diagram of a panoramic video processing device, according to some aspects of the present disclosure.

FIG. 14 is another structural block diagram of a panoramic video processing, according to some aspects of the present disclosure.

FIG. 15 is an internal structural diagram of a computer device, according to some aspects of the present disclosure.

The present disclosure will be described with reference to the accompanying drawings.

### DETAILED DESCRIPTION

In order to make the objectives, technical solutions, and advantages of the present disclosure clearer, the following provides a further detailed description of the present disclosure in conjunction with the accompanying drawings and implementations. It should be understood that the specific implementations described herein are merely for the purpose of explaining the present disclosure and are not intended to limit the present disclosure.

Unless otherwise defined, all technical and scientific terms used herein have the same meaning as commonly understood by those skilled in the art to which this application belongs; the terminology used herein is for the purpose of describing particular implementations only and is not intended to be limiting of the present disclosure; and the terms “include,” “have,” and any variations thereof as used in the specification, claims, and above description of the drawings are intended to cover non-exclusive inclusions.

In the description of the implementations of the present disclosure, technical terms such as “first,” “second,” etc., are only used to distinguish different objects and should not be construed as indicating or implying relative importance or implicitly indicating the number, specific order, or priority of the indicated technical features. In the description of the implementations of the present disclosure, “a plurality of” means two or more, unless otherwise specifically defined.

References to “implementation(s)” herein mean that a particular feature, structure, or characteristic described in connection with the implementation may be included in at least one implementation of the present disclosure. The appearance of such phrases in various places in the specification does not necessarily refer to the same implementation, nor are they mutually exclusive alternative or independent implementations. Those skilled in the art will explicitly and implicitly understand that the implementations described herein may be combined with other implementations.

A panoramic video is a type of video captured in all directions at 360 degrees using a panoramic camera, allowing interactive control of the viewing perspective. As panoramic video is required to cover 360 degrees of content, the bitrate of a complete panoramic video is generally very high. Therefore, transmitting a complete panoramic video usually requires a large network bandwidth to ensure smooth video transmission.

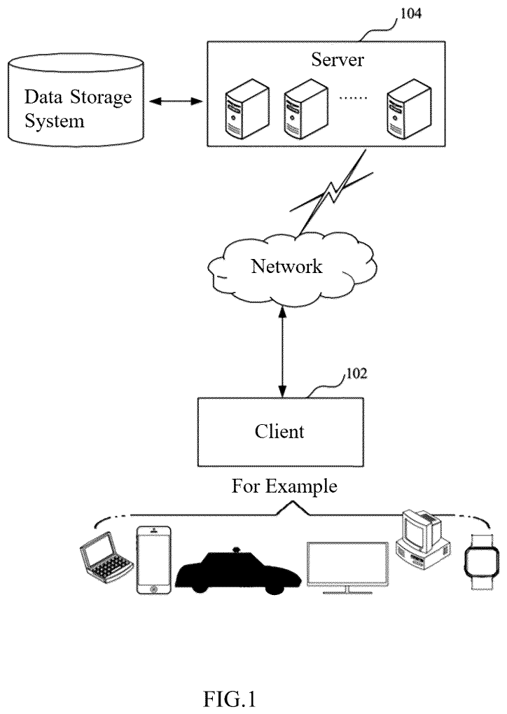

The following briefly describes the implementation environment involved in the panoramic video processing method provided by the implementations of the present disclosure. The panoramic video processing method provided by the implementations of the present disclosure can be applied in the application environment shown in FIG. 1. As shown, a client 102 can be configured to communicate with a server 104 via a network. The data storage system can store data that the server 104 needs to process. In some implementations, the data storage system can be integrated into the server 104, or can be placed in the cloud or on another network server. The client 102 can be a terminal, for example, but not limited to, various personal computers, notebook computers, smartphones, tablet computers, Internet of Things (IoT) devices, and portable wearable devices. The IoT devices may be smart speakers, smart TVs, smart air conditioners, smart in-vehicle devices, etc. The portable wearable devices may be smart watches, smart bands, head-mounted devices, etc. The server 104 can be implemented as a standalone server or a server cluster composed of multiple servers.

Those skilled in the art can understand that the structure shown in FIG. 1 is only a block diagram of the relevant part of the present disclosure scheme and does not constitute a limitation on the server to which the present disclosure scheme is applied. The specific server may include more or fewer components than those shown in the figure, or combine certain components, or have different component arrangements.

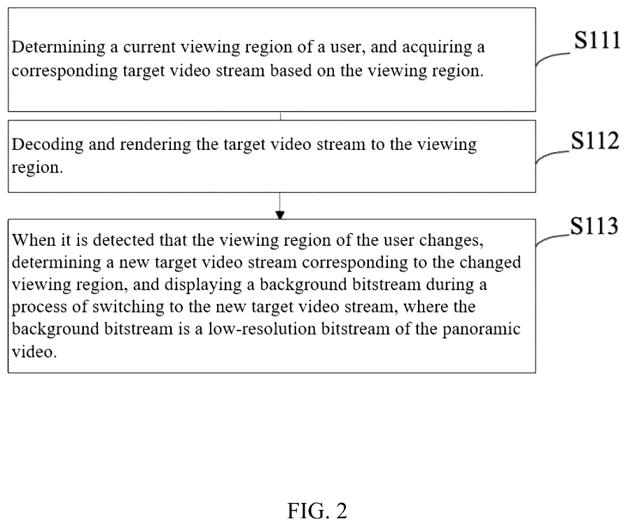

In some implementations, as shown in FIG. 2, a panoramic video processing method is provided. Taking the application of this method to the client in FIG. 1 as an example, the method includes the following operations.
S111: Determining a current viewing region of a user, and acquiring a corresponding target video stream based on the viewing region.

In some implementations of the present disclosure, the longitude range of the panoramic video is 0˜360 degrees and the latitude range is 0˜180 degrees, while the user usually only watches part of the region when viewing the panoramic video. Therefore, in some implementations of the present disclosure, there is no need to transmit and decode the picture for the region not being viewed by the user. Based on this, the client can determine the position of the user's current viewing region in the panoramic video, and based on the viewing region, acquire the target video stream corresponding to the viewing region from the panoramic video. The target video stream refers to the video corresponding to the region that needs to be transmitted and decoded.

In some implementations, the operation of determining the target video stream may include but is not limited to the following two implementations. First, assuming that the panoramic video has not been segmented into multiple slice videos, the client can directly acquire the target video stream corresponding to the viewing region from the panoramic video based on the viewing region. Second, assuming that the panoramic video has been pre-segmented into multiple slice videos, the client can determine the video slice index corresponding to the viewing region from the indices of the multiple slice videos in the panoramic video based on the viewing region, and determine the slice video corresponding to the video slice index as the target video stream corresponding to the viewing region.
S112: Decoding and rendering the target video stream to the viewing region.

In some implementations of the present disclosure, the client can decode the target video stream and render the decoded target video stream to the user's current viewing region. For instance, some implementations of the present disclosure only need to decode and render the target video stream, without decoding and rendering the entire panoramic video. Therefore, the network bandwidth in the panoramic video processing process can be greatly reduced.
S113: When it is detected that the viewing region of the user changes, determining a new target video stream corresponding to the changed viewing region, and displaying a background bitstream during a process of switching to the new target video stream, where the background bitstream may include a low-resolution bitstream of the panoramic video.

In some implementations of the present disclosure, the client can monitor the user's current viewing region in real time, and when it is detected that the viewing region of the user changes, determine the changed viewing region, and based on the changed viewing region, determine the new target video stream corresponding to the changed viewing region. Then, the client can pull the new target video stream. In some implementations, there are two bitstreams on the client, one being the slice video stream and the other being the background bitstream. The client can also display the background bitstream on the display interface of the client during the process of switching to the new target video stream, and immediately display the new target video stream on the display interface of the client after the client pulls the new target video stream. The background bitstream is a low-resolution bitstream of the panoramic video.

In the above panoramic video processing method, a current viewing region of a user is determined, and a corresponding target video stream is acquired based on the viewing region; the target video stream is decoded and rendered to the viewing region; when it is detected that the viewing region of the user changes, a new target video stream corresponding to the changed viewing region is determined, and a background bitstream is displayed during a process of switching to the new target video stream, where the background bitstream is a low-resolution bitstream of the panoramic video. Since the user usually only watches part of the content when viewing the panoramic video, the present disclosure can process only the target video stream corresponding to the viewing region, without transmitting and processing the entire panoramic video, which can greatly reduce the network bandwidth in the transmission and processing of panoramic video, and does not affect the effect of the user watching the slice video, thereby ensuring smooth and efficient transmission and visual quality of panoramic video under low bandwidth.

In some aspects, an implementation for displaying the background bitstream is provided. The above panoramic video processing method further includes:
when it is detected that a display cannot normally display the target video stream, displaying the background bitstream.

In some implementations of the present disclosure, since there are two bitstreams on the client, one is the slice video stream and the other is the background bitstream, the client can detect in real time or periodically whether the display can normally display the target video stream during the process of switching to the new target video stream. If the client detects that the display can normally display the target video stream, the client can display the target video stream on the display interface of the client. On the other hand, if the client detects that the display fails to normally display the target video stream, the client can display the background bitstream on the display interface of the client. For example, the situations where the display cannot normally display the target video stream may include but is not limited to the situation where the target video stream cannot be pulled from the server in time, or the situation where the target video stream cannot be decoded and rendered to the viewing region in time, etc.

In some implementations, when it is detected that the display cannot normally display the target video stream, the background bitstream can be displayed, which can improve the effect of the user watching the panoramic video.

In some aspects, an implementation for displaying the background bitstream is provided. For instance, when the client executes the above “when it is detected that a display cannot normally display the target video stream, displaying the background bitstream,” it may include:
when the target video stream cannot be pulled from a server in time, displaying the background bitstream on the display.

In some implementations of the present disclosure, the client can detect in real time or periodically whether the target video stream can be pulled from the server in time during the process of switching to the new target video stream. If the client detects that the display can pull the target video stream from the server in time, the client can display the target video stream on the display interface of the client. On the other hand, if the client detects that the target video stream cannot be pulled from the server in time, the client can display the background bitstream on the display interface of the client.

In some implementations, when the target video stream cannot be pulled from the server in time, the background bitstream can be displayed on the display, which can improve the effect of the user watching the panoramic video.

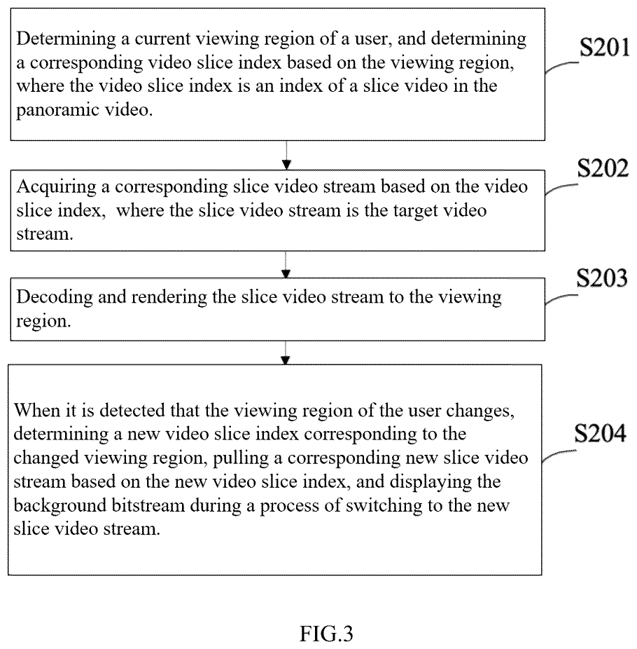

In some aspects, as shown in FIG. 3, an implementation for acquiring the target video stream corresponding to the viewing region is provided. When the client executes S111 “determining a current viewing region of a user, and acquiring a corresponding target video stream based on the viewing region,” it may include:
S201: Determining a current viewing region of a user, and determining a corresponding video slice index based on the viewing region, where the video slice index may include an index of a slice video in the panoramic video.

In some implementations of the present disclosure, the client can determine the position of the user's current viewing region in the panoramic video, and based on the viewing region, determine the video slice index corresponding to the viewing region from the indices of the multiple slice videos in the panoramic video.

In some implementations, the operation of determining the video slice index corresponding to the viewing region may include but is not limited to the following two implementations. First, in the case where one index corresponds to multiple different resolution levels, the client can first determine at least one index of a slice video corresponding to the viewing region based on the position of the user's current viewing region in the panoramic video, then obtain multiple resolutions corresponding to the at least one index of the slice video, and select a target resolution set in the preset clarity requirement from the multiple resolutions according to the preset clarity requirement. As such, the index of the at least one slice video with the resolution being the target resolution can be determined as the video slice index. Second, in the case where one index corresponds to only one resolution, the client can first determine at least one index of a slice video corresponding to the viewing region based on the position of the user's current viewing region in the panoramic video, and then directly determine the at least one index of the slice video as the video slice index.
S202: Acquiring a corresponding slice video stream based on the video slice index, where the slice video stream may be the target video stream.

In some implementations of the present disclosure, in some implementations, the implementation for the client to acquire a corresponding slice video stream based on the video slice index may include but is not limited to the following two ways: First, if the panoramic video and the multiple slice videos in the panoramic video have been pre-stored locally on the client, the client can directly read the slice video stream corresponding to the video slice index from the local disk. Second, if the panoramic video and the multiple slice videos in the panoramic video have been pre-stored on the server, the client can send the video slice index to the server. Consequently, the server can determine the slice video stream corresponding to the video slice index based on the video slice index, and send the slice video stream corresponding to the video slice index to the client. Accordingly, the client can receive the slice video stream corresponding to the video slice index.

Operation S112 may include:
S203: Decoding and rendering the slice video stream to the viewing region.

In some implementations of the present disclosure, as the slice video stream can be the target video stream, the client can be configured to decode the slice video stream and render the decoded slice video stream to the user's current viewing region For instance, some implementations of the present disclosure only need to decode and render the slice video corresponding to the video slice index, without decoding and rendering the entire panoramic video, which can greatly reduce the network bandwidth in the panoramic video processing process.

Operation S113 may include:
S204: When it is detected that the viewing region of the user changes, determining a new video slice index corresponding to the changed viewing region, pulling a corresponding new slice video stream based on the new video slice index, and displaying the background bitstream during a process of switching to the new slice video stream.

In some implementations of the present disclosure, the client can monitor the user's current viewing region in real time, and when it is detected that the viewing region of the user changes, determine the changed viewing region, and based on the changed viewing region, determine the new video slice index corresponding to the changed viewing region. Then, the client can pull the corresponding new slice video stream based on the new video slice index. The operations of determining the new video slice index and acquiring the new slice video stream can refer to operations S201 and S202, which will not be repeated here.

In addition, since there are two bitstreams on the client, one is the slice video stream and the other is the background bitstream, the client can also display the background bitstream on the display interface of the client during the process of switching to the new slice video stream, and immediately display the slice video stream on the display interface of the client after the client pulls the new slice video stream. The background bitstream is a low-resolution bitstream of the panoramic video.

In this implementation, since the user usually only watches part of the content when viewing the panoramic video, the present disclosure can process only the slice video stream corresponding to the viewing region, without transmitting and processing the entire panoramic video, which can greatly reduce the network bandwidth in the transmission and processing of panoramic video, and does not affect the effect of the user watching the slice video, thereby ensuring smooth and efficient transmission and visual quality of panoramic video under low bandwidth.

In one implementation, an implementation for acquiring the video slice index corresponding to the viewing region is provided. For instance, when the client executes the above S202 “acquiring a corresponding slice video stream based on the video slice index,” it may include:
S211: Sending the video slice index to a server, wherein the server can be configured to determine a slice video stream to be sent based on the video slice index; and
S212: Receiving the slice video stream sent by the server.

In some implementations of the present disclosure, the client can send the determined video slice index corresponding to the viewing region to the server. Subsequently, the server can determine the slice video stream based on the received video slice index and send the slice video stream to the client. The video slice index is an index of a slice video in the panoramic video, and the slice video stream refers to the slice video corresponding to the video slice index, and the slice video refers to a video containing a local picture of the panoramic video. Then, the client can receive the slice video stream sent by the server. For instance, some implementations of the present disclosure only need to transmit the slice video corresponding to the video slice index, without transmitting the entire panoramic video, which can greatly reduce the network bandwidth in the transmission process of panoramic video.

In this implementation, the video slice index is sent to a server, and accordingly the server can determine a slice video stream to be sent based on the video slice index; and the slice video stream sent by the server is received. If each slice video in the panoramic video is pre-stored on the server, the slice video stream corresponding to the video slice index can be acquired from the server based on the video slice index. Accordingly, only the slice video stream corresponding to the viewing region needs to be transmitted and processed, without transmitting and processing the entire panoramic video, which can greatly reduce the network bandwidth in the transmission and processing of panoramic video, and does not affect the effect of the user watching the slice video, thereby ensuring smooth and efficient transmission and visual quality of panoramic video under low bandwidth.

In one implementation, different resolution slice videos are stored on the server for the same slice.

The video slice index can include a layer index and a slice index of the same layer, wherein each layer corresponds to a distinct resolution, and slices within a same layer share a same resolution.

The layer index refers to the index of each layer contained in the slice video, and the slice index of the same layer refers to the index of each slice video contained in the same layer. It should be noted that the layers are divided based on resolution. For instance, different layers correspond to different resolutions, and the same layer corresponds to the same resolution.

In this implementation, by setting different resolutions for different layers of the slice video, the most suitable resolution can be selected from different resolutions according to the preset clarity requirement. Accordingly, only the slice video corresponding to the most suitable resolution needs to be transmitted and processed, which can ensure the clarity of the transmitted and processed slice video stream.

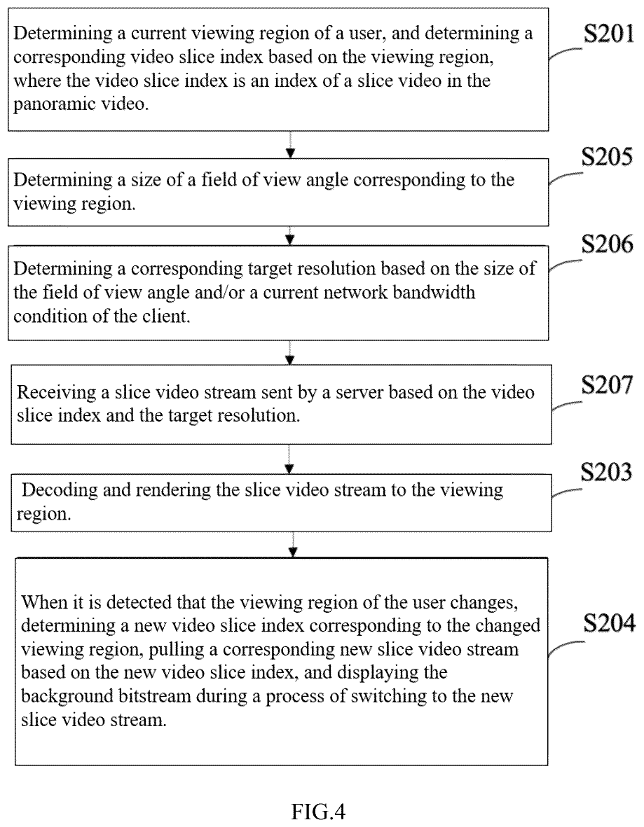

In one implementation, different resolution slice videos are stored on the server for the same slice, and as shown in FIG. 4, the above panoramic video processing method may further include the following operations:
S205: Determining a size of a field of view angle corresponding to the viewing region.
S206: Determining a corresponding target resolution based on the size of the field of view angle and/or a current network bandwidth condition of the client.

Operation S202 may include:
S207: Receiving a slice video stream sent by a server based on the video slice index and the target resolution.

In some implementations of the present disclosure, the client can pre-determine the current network bandwidth condition of the client, and after determining the user's current viewing region, determine the size of the field of view (FOV) angle corresponding to the viewing region, and then determine the target resolution corresponding to the viewing region based on the size of the field of view angle and/or the current network bandwidth condition of the client. Then, the client can send the target resolution corresponding to the viewing region to the server. The client can also send the video slice index to the server, and accordingly, the server can determine the slice video stream corresponding to the viewing region based on the video slice index and the target resolution, and send the slice video stream corresponding to the viewing region to the client. Then, the client can receive the slice video stream sent by the server based on the video slice index and the target resolution. The target resolution refers to the resolution suitable for the user to watch the slice video corresponding to the current viewing region.

In this implementation, the client can determine the corresponding target resolution based on the determined size of the field of view angle and/or the current network bandwidth condition of the client, and transmit the corresponding target resolution to the server. Accordingly, the server can accurately determine the slice video stream corresponding to the viewing region that meets the target resolution requirement based on the video slice index and the target resolution, so that the client can receive the accurate slice video stream.

In one implementation, different resolution slice videos are stored on the server for the same slice, including:
the server determines a search range corresponding to each coding block within each slice video.

In some implementations of the present disclosure, the server determines a search range corresponding to each coding block within each slice video. In some implementations, the server can determine the search range corresponding to each coding block for each slice video based on the size of the slice video and the position of the coding block in the slice video. In some implementations, the server can also determine the search range corresponding to the current coding block based on the coordinates of the current coding block, the width of the current coding block, and the height of the current coding block, taking into account the possible image edge errors caused by sub-pixel interpolation. The search range refers to the search range corresponding to each coding block in the slice video. It should be noted that the purpose of setting the search range in the implementations of the present disclosure is to ensure that the reference block found is located within the same slice video, and cannot cross other slice videos or use pixels from other slice videos (i.e., the reference block found is required to remain within the same slice video to ensure independence), so as to ensure the relative independence between slice videos, thereby ensuring that no decoding errors occur when the slice videos are stitched together later. Of course, the implementations of the present disclosure do not limit the specific way of determining the search range. In addition to the above-mentioned way of determining the search range, for example, the search range corresponding to the current coding block can also be determined based on the coordinates of the current coding block, the width of the current coding block, and the height of the current coding block, taking into account the possible image edge errors caused by sub-pixel interpolation.

The server performs motion search in each search range, to obtain a motion vector corresponding to each search range.

In some implementations of the present disclosure, the server can perform motion search for each coding block within the corresponding search range of each coding block, to obtain a motion vector (MV) corresponding to each search range. It should be noted that the current coding block can only be searched within the search range where the coding block is located during motion search, and if the search result involves sub-pixels, since sub-pixels are calculated from integer pixels, it is also necessary to ensure that the pixels for calculating these sub-pixels are also within the search range, so as to ensure the relative independence between slice videos.

The server encodes each slice video based on the motion vector corresponding to each search range, to obtain a plurality of encoded slice videos.

In some implementations of the present disclosure, for each slice video, the server can calculate the pixel residual based on the motion vector corresponding to each search range, perform DCT (Discrete Cosine Transform) and quantization on the pixel residual, and then perform entropy coding on the processed slice video to obtain a plurality of encoded slice videos.

The server stores the plurality of encoded slice videos.

In some implementations of the present disclosure, the server can store the plurality of encoded slice videos in a video database, and set a corresponding index for each slice video. It should be noted that the slice video and the index are in a one-to-one correspondence.

In this implementation, in order to ensure that a plurality of slice video streams can be merged into one video stream, it is necessary to set the search range corresponding to each coding block on the server when encoding each slice video, to limit the search range of inter-frame predictive coding, so as to ensure the relative independence between slice videos, and ensure that the motion vector in each determined slice video cannot exceed the range of the current slice video, thereby ensuring that no decoding errors occur when the slice videos are stitched together later, and that the merged slice video streams can still be decoded normally.

In one implementation, the panoramic video can include a fisheye image captured by a fisheye camera; and different resolution slice videos can be stored on the server for the same slice, including:
the server can be configured to map the fisheye image to a preset unfolded image based on a mapping relationship between the fisheye images and the unfolded images.

In some implementations of the present disclosure, for each pixel in an unfolded image, the server can first project each pixel in the unfolded image onto a unit sphere according to the cubemap projection relationship, to obtain the three-dimensional point corresponding to each pixel in the unfolded image on the unit sphere, and then project the three-dimensional point corresponding to each pixel onto the fisheye image according to the fisheye calibration information, to obtain the corresponding point of each pixel on the fisheye image, so as to obtain the mapping relationship between the fisheye images and the unfolded images.

In addition, a seamless stitching algorithm can also be used to adjust the obtained mapping relationship, so that the images at the stitching seams are aligned, ghosting and discontinuities are eliminated, and the cubemap unfolded image has a seamless stitching effect. The mapping relationship between the fisheye images and the unfolded images can be in the form of a graph or table, and some implementations of the present disclosure do not limit the specific form of the mapping relationship between the fisheye images and the unfolded images.

Subsequently, the server can map the fisheye image captured by the fisheye camera to the preset unfolded image based on the mapping relationship between the fisheye images and the unfolded images. In some implementations, the preset unfolded image may refer to a cubemap unfolded image that only includes position information and does not contain color information.

The server performs image rendering on the preset unfolded image based on preset different resolutions, to obtain a cubic unfolded image corresponding to the different resolutions.

In some implementations of the present disclosure, the server can perform image rendering on the preset unfolded image based on preset different resolutions, to obtain a cubic unfolded image corresponding to the different resolutions. In some implementations, the server can perform different image rendering on the preset unfolded image based on the preset different resolutions, to obtain a cubic unfolded image corresponding to the different resolutions. In some examples, the server can first perform image rendering on the preset unfolded image based on the maximum resolution among the preset different resolutions, to generate a cubic unfolded image corresponding to the maximum resolution, and then perform downsampling on the cubic unfolded image corresponding to the maximum resolution based on the preset different resolutions among the preset different resolutions, to obtain a cubic unfolded image corresponding to the different resolutions. The present disclosure does not limit any specific implementation of generating the cubic unfolded image. For the stitching region, image fusion operations are also required during the image rendering process, and the implementations of the present disclosure do not limit the specific implementation of image fusion.

It should be noted that the present disclosure can also implement the extension process of the cubemap face. In some examples, each unfolded cubemap face corresponding to the cubic unfolded image has an extra part of the image around each unfolded cubemap face compared to the actual cubemap face, and the content of the extra part is the same as the edge content of the adjacent cubemap face. When rendering the edge pixels of the cubemap face, the above extended image content can be sampled within the same cubemap face, without cross-cubemap sampling (i.e., sampling from multiple cubemap faces), so as to facilitate the rendering sampling of edge pixels.

The server segments the cubic unfolded image based on a segmentation requirement, to obtain a plurality of slice videos.

In some implementations of the present disclosure, the server can segment the cubic unfolded image based on a segmentation requirement, to obtain a plurality of slice videos. The segmentation requirement may include preset segmentation size, preset segmentation shape, etc., and the implementations of the present disclosure do not limit the segmentation requirement. For example, if the segmentation requirement requires the slice to be a rectangle with width W and height H, and the size of the overlapping region between adjacent slices is O, then the coordinates of the upper left vertex of the slice video in the y-th row and x-th column after segmentation in the cubic unfolded image are (x*(W−O), y*(H−O)).

In some implementations, the server can map the fisheye image to the preset unfolded image based on the mapping relationship between the fisheye image and the unfolded image, and the server can perform image rendering on the preset unfolded image based on preset different resolutions, to obtain a cubic unfolded image corresponding to the different resolutions. In this way, the server can comprehensively consider the processing cost, bandwidth, and client image quality experience of the panoramic video, and determine the most suitable resolution for each layer, so as to generate a cubic unfolded image corresponding to different resolutions based on the most suitable resolution for each layer. Then, the server can segment the cubic unfolded image corresponding to different resolutions based on the segmentation requirement, to obtain a plurality of slice videos with more uniform pixel density.

In some implementations, different resolution slice videos are stored on the server for the same slice, as shown in FIG. 5, and the above panoramic video processing method may further include:
S208: Determining a size of a field of view angle corresponding to the viewing region, and sending the size of the field of view angle to the server, so that the server determines a corresponding target resolution based on the size of the field of view angle and/or a current network bandwidth condition of the client, and determines a slice video stream to be sent based on the video slice index and the target resolution.

In some implementations of the present disclosure, after determining the user's current viewing region, the client can determine the size of the field of view angle corresponding to the viewing region and send the size of the field of view angle to the server. In addition, the client can also pre-determine the current network bandwidth condition of the client and send the current network bandwidth condition of the client to the server. The client can also send the video slice index to the server, so that the server can determine the target resolution corresponding to the viewing region based on the received size of the field of view angle and/or the current network bandwidth condition of the client, and then determine the slice video stream to be sent based on the video slice index and the target resolution, and send the slice video stream corresponding to the viewing region to the client. Then, the client can receive the slice video stream sent by the server based on the video slice index and the target resolution.

In this implementation, by transmitting the size of the field of view angle corresponding to the viewing region and/or the current network bandwidth condition of the client to the server, the server can accurately determine the target resolution based on the size of the field of view angle and/or the current network bandwidth condition of the client, so as to accurately determine the slice video stream corresponding to the viewing region that meets the target resolution requirement based on the video slice index and the target resolution.

In one implementation, an implementation for determining the video slice index corresponding to the viewing region is provided. For instance, when the client executes the above S201 “determining a corresponding video slice index based on the viewing region,” the specific operations include:
determining the video slice index based on a position of a projection of each pixel in the viewing region on the panoramic video.

In some implementations of the present disclosure, the client can calculate the position of the projection of each pixel in the viewing region on the panoramic video based on the user's current viewing region, so as to determine the number of required slice videos and the video slice index based on the position of the projection of each pixel in the viewing region on the panoramic video. Suppose the number of slice videos is K, and the total number of slice videos corresponding to the panoramic video is N, then K<N/2. In this way, only K/N of the hardware decoding capability and K/N of the transmission bandwidth of the original panoramic video are needed to transmit and process 8K panoramic video, which can not only reduce the bandwidth requirement for watching 8K panoramic video, but also reduce the requirement for the user's machine performance, for example, reducing the requirement for the user's machine decoding capability. As the decoding resolution is reduced, the power consumption can also be reduced accordingly.

In this implementation, by determining the video slice index based on the position of the projection of each pixel in the viewing region on the panoramic video, the video slice index can be accurately determined, so that only the slice video stream corresponding to the video slice index needs to be transmitted and processed, which can not only reduce the bandwidth requirement for watching 8K panoramic video, but also reduce the requirement for the user's machine decoding capability.

In one implementation, determining the video slice index based on the position of the projection of each pixel in the viewing region on the panoramic video includes:
determining a rendering window based on a view angle parameter of a current rendered image corresponding to the viewing region;
determining a target pixel falling in the rendering window on a cubic unfolded image corresponding to the panoramic video; and
determining the video slice index based on the target pixel.

In some implementations of the present disclosure, the client can pre-acquire the view angle parameter of the current rendered image corresponding to the viewing region, and convert the panoramic video into a cubic unfolded image. Then, the client can determine the rendering window based on the view angle parameter of the current rendered image corresponding to the viewing region, so as to locate the region where the current rendered image is located in the cubic unfolded image according to the projection transformation relationship between the current rendered image and the cubic unfolded image. For instance, all the pixels in the region can be determined as the target pixels falling in the rendering window on the cubic unfolded image corresponding to the panoramic video. Then, the client can count the indices of the slice videos corresponding to the target pixels and determine the indices of the slice videos corresponding to the target pixels as the video slice index.

In this implementation, by accurately determining the rendering window based on the view angle parameter of the current rendered image corresponding to the viewing region, the target pixels falling in the rendering window on the cubic unfolded image corresponding to the panoramic video can be accurately determined, and then the indices of the slice videos corresponding to the target pixels can be determined as the video slice index. For instance, the video slice index can be accurately determined.

In one implementation, determining the target pixel falling in the rendering window on the cubic unfolded image corresponding to the panoramic video includes:
projecting each pixel in the cubic unfolded image onto a plane where the rendering window is located, to obtain a mask image corresponding to the cubic unfolded image, where a gray value of a pixel contained in the rendering window in the mask image is a first value, and a gray value of a pixel contained in another region in the mask image is a second value; and
determining the target pixel falling in the rendering window on the cubic unfolded image based on the mask image.

In some implementations of the present disclosure, the client can project each pixel in the cubic unfolded image corresponding to the panoramic video onto the plane where the rendering window is located, to obtain a mask image corresponding to the cubic unfolded image. In the mask image, the gray value of a pixel contained in the rendering window is a first value, and the gray value of a pixel contained in another region is a second value. For example, the first value can be 255, and the second value can be 0. Thus, the client can count the pixels with the first value in the mask image corresponding to the cubic unfolded image, and determine the pixels with the first value as the target pixels falling in the rendering window on the cubic unfolded image.

In this implementation, by constructing the mask image, the target pixels falling in the rendering window on the cubic unfolded image corresponding to the panoramic video can be accurately determined, so that the video slice index can be accurately determined based on the accurate target pixels.

In one implementation, projecting each pixel in the cubic unfolded image onto the plane where the rendering window is located, to obtain the mask image corresponding to the cubic unfolded image includes:
projecting each pixel in the cubic unfolded image onto the plane where the rendering window is located, to obtain projected pixels; and
setting a gray value of a pixel located in the rendering window to the first value, and setting a gray value of another pixel to the second value, to obtain the mask image.

For example, for each pixel in the cubic unfolded image, the client can project each pixel in the cubic unfolded image onto the plane where the rendering window is located according to the projection relationship between the cubic unfolded image and the rendering window, to obtain the projected pixels. Then, the client can determine whether the projected pixels are within the range of the rendering window. If the projected pixels are within the range of the rendering window, the client can set the gray value of the pixels located in the rendering window to the first value; and if the projected pixels are not within the range of the rendering window, the client can set the gray value of the other pixels not within the range of the rendering window to the second value, so as to obtain the mask image.

In this implementation, by projecting each pixel in the cubic unfolded image onto the plane where the rendering window is located, to obtain the projected pixels, and setting the gray value of the pixels located in the rendering window to the first value, and setting the gray value of the other pixels to the second value, the mask image can be accurately constructed based on whether each pixel is projected into the rendering window, so that the target pixels falling in the rendering window on the cubic unfolded image corresponding to the panoramic video can be accurately determined, and the video slice index can be accurately determined based on the accurate target pixels.

In some aspects, some implementations for decoding and rendering the slice video is provided. For instance, when the client executes operation S203 “decoding and rendering the slice video stream to the viewing region,” it may include:
merging the slice video stream to obtain a merged video stream;
decoding the merged video stream to obtain decoded frame data; and
uploading the decoded frame data to a renderer, and determining a position of each pixel in the viewing region on the decoded frame data by the renderer, to render the decoded frame data to the viewing region.

In the related art, when the client decodes multiple slice video streams, it is necessary to call multiple decoders to decode multiple slice video streams separately, which affects the performance of the client, and when the number of slice streams is large, the client does not have enough decoders to decode. Based on this, in some implementations of the present disclosure, when the viewing region corresponds to multiple slice video streams, the client can first merge the slice video streams corresponding to the video slice index to obtain a merged video stream, and then decode the merged video stream to obtain decoded frame data. Then, the client can upload the decoded frame data to the renderer, and the renderer can calculate the position of each pixel in the viewing region on the decoded frame data based on the current viewing region, so as to render the decoded frame data to the viewing region. For example, the client can project each pixel in the rendering window corresponding to the viewing region onto the corresponding slice of the cubic unfolded image according to the projection relationship between the rendering window and the slice of the cubic unfolded image, and then perform pixel sampling and image rendering for each pixel in the rendering window corresponding to the viewing region from the slice.

In this implementation, by first merging the slice video streams, and then decoding and rendering the merged video stream, a single decoder can be used to decode the merged video stream, so that the client will not have the problem of not having enough decoders to decode due to pulling too many slice video streams, and the decoding power consumption of the client can be reduced.

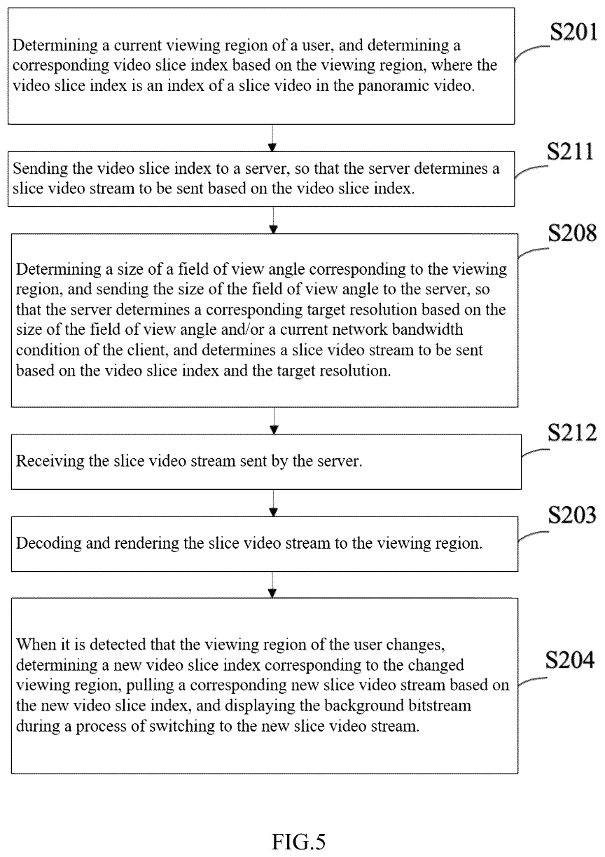

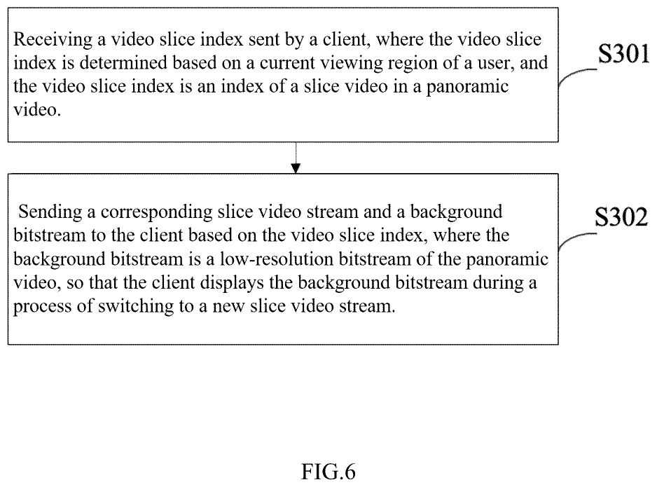

In one implementation, as shown in FIG. 6, a panoramic video processing method is provided. Taking the application of this method to the server corresponding to the server side in FIG. 1 as an example, the method may include the following operations:
S301: Receiving a video slice index sent by a client, where the video slice index is determined based on a current viewing region of a user, and the video slice index is an index of a slice video in a panoramic video.

In some implementations of the present disclosure, since the client can send the determined video slice index corresponding to the viewing region to the server, the server side corresponding to the server can receive the video slice index sent by the client. The video slice index is determined by the client based on the user's current viewing region from the indices of the multiple slice videos in the panoramic video, and the video slice index is an index of a slice video in the panoramic video. The specific operations for the client to determine the video slice index can refer to the above implementations, which will not be repeated here.
S302: Sending a corresponding slice video stream and a background bitstream to the client based on the video slice index, where the background bitstream is a low-resolution bitstream of the panoramic video, so that the client displays the background bitstream during a process of switching to a new slice video stream.

In some implementations of the present disclosure, the server can determine the slice video stream corresponding to the video slice index from the multiple slice videos in the panoramic video based on the received video slice index, and the server can pre-set the background bitstream, so that the server can send the slice video stream corresponding to the video slice index and the background bitstream to the client, so that the client displays the background bitstream during a process of switching to a new slice video stream. The background bitstream is a low-resolution bitstream of the panoramic video.

In the above panoramic video processing method, a video slice index sent by a client is received, where the video slice index is determined based on a current viewing region of a user, and the video slice index is an index of a slice video in a panoramic video; and a corresponding slice video stream and a background bitstream is sent to the client based on the video slice index, where the background bitstream is a low-resolution bitstream of the panoramic video, so that the client displays the background bitstream during a process of switching to a new slice video stream. Since the user usually only watches part of the content when viewing the panoramic video, the present disclosure can transmit and process only the slice video stream corresponding to the viewing region, without transmitting and processing the entire panoramic video, which can greatly reduce the network bandwidth in the transmission process of panoramic video, and does not affect the effect of the user watching the slice video, thereby ensuring smooth and efficient transmission and visual quality of panoramic video under low bandwidth. It has been verified that when the panoramic video processing method of the present disclosure is used for real-time transmission and processing of panoramic video, the transmission bandwidth can be reduced to 20%˜25% of the original transmission bandwidth while ensuring sufficient visual quality of the panoramic video.

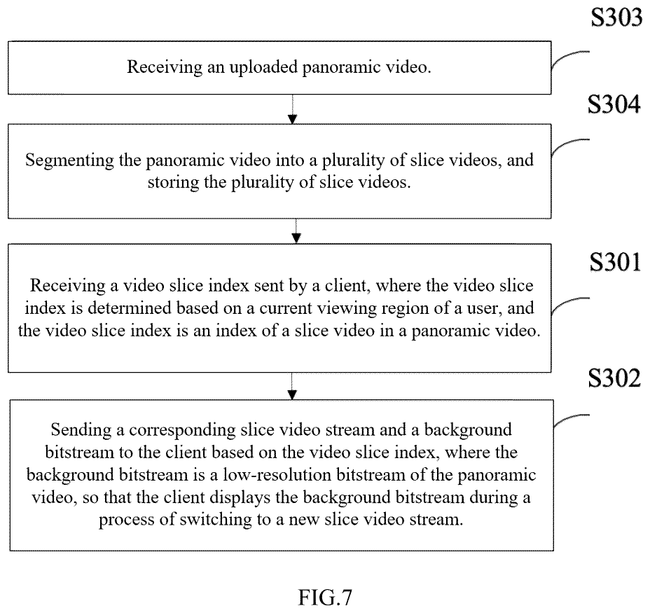

In one implementation, as shown in FIG. 7, the above panoramic video processing method may further include:
S303: Receiving an uploaded panoramic video.

In some implementations of the present disclosure, in some implementations, the camera can pre-capture the panoramic video and send the captured panoramic video to the server, so that the server can acquire the panoramic video captured by the client. In some examples, the camera can pre-capture the panoramic video and store the captured panoramic video in the cloud, so that the server can receive the uploaded panoramic video from the cloud. Of course, the implementations of the present disclosure do not limit the specific implementation of acquiring the panoramic video.
S304: Segmenting the panoramic video into a plurality of slice videos, and storing the plurality of slice videos.

In some implementations of the present disclosure, the server can directly segment the panoramic video into a plurality of slice videos. In some implementations, the server can first perform format conversion processing on the panoramic video to obtain a format conversion processed panoramic video, and then segment the format conversion processed panoramic video into a plurality of slice videos. The format of the panoramic video may include but is not limited to fisheye image format or panoramic image format, etc. For example, if the panoramic video is in panoramic image format, the server can directly segment the panoramic image into a plurality of slice videos; and if the panoramic video is in fisheye image format, the server can first convert the fisheye image into a cubic unfolded image, and then segment the cubic unfolded image into a plurality of slice videos. Then, the server can store the plurality of slice videos. In some implementations, the plurality of slice videos can be stored in a preset database or memory, etc., and the implementations of the present disclosure do not limit the storage location of the plurality of slice videos.

In this implementation, by receiving the uploaded panoramic video, segmenting the panoramic video into a plurality of slice videos, and storing the plurality of slice videos, a plurality of slice videos corresponding to the panoramic video can be obtained.

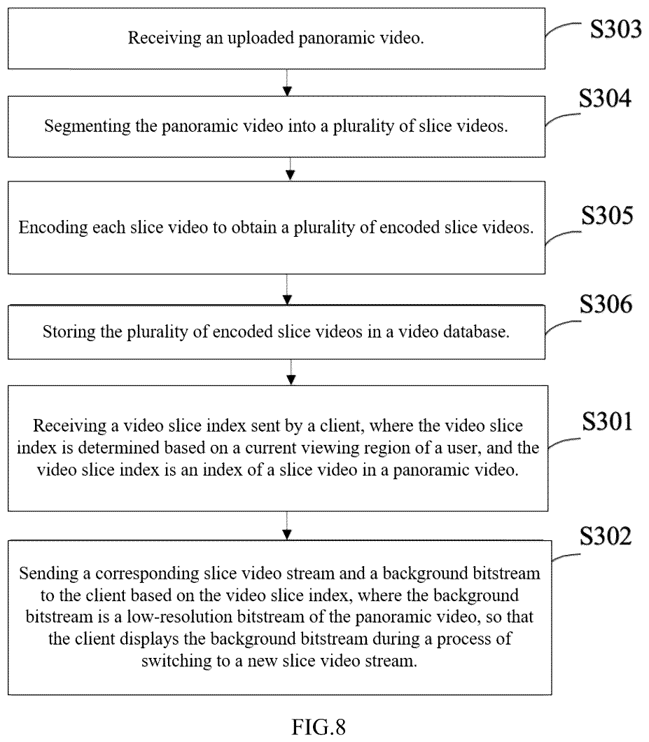

In one implementation, as shown in FIG. 8, the above panoramic video processing method may further include:
S305: Encoding each slice video to obtain a plurality of encoded slice videos.

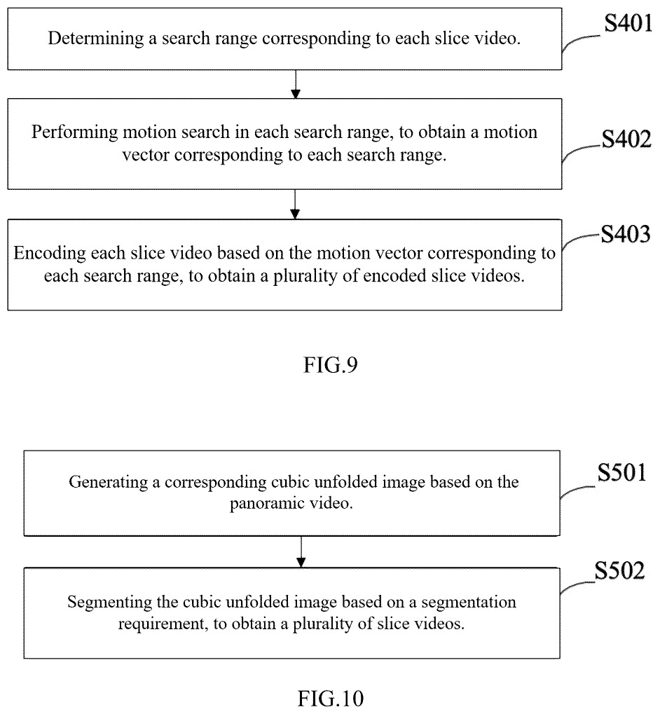

In some implementations of the present disclosure, the server can encode each slice video using a preset video encoding method to obtain a plurality of encoded slice videos. The preset video encoding method may include but is not limited to H.264 (Advanced Video Coding), H.265 (High Efficiency Video Coding), AV1 (AOMedia Video 1), etc. Generally, the video encoding process includes intra-frame predictive coding and inter-frame predictive coding. The intra-frame predictive coding may include: first, for each slice video, acquiring the reference pixels required for intra-frame prediction from each slice video; then, filtering the reference pixels; then, selecting the optimal intra-frame prediction mode from various intra-frame prediction modes according to the principle of minimum rate-distortion cost; then, performing intra-frame predictive coding using the optimal intra-frame prediction mode to obtain each encoded slice video. It should be noted that the implementations of the present disclosure improve the inter-frame predictive coding operation, and the specific inter-frame predictive coding operation can be found in some implementations corresponding to FIG. 9 below.

Operation in S304 “storing the plurality of slice videos” may include:
S306: Storing the plurality of encoded slice videos in a video database.

In some implementations of the present disclosure, the server can store the plurality of encoded slice videos in a video database, and set a corresponding index for each slice video. It should be noted that the slice video and the index are in a one-to-one correspondence.

In this implementation, in order to ensure that a plurality of slice video streams can be merged into one video stream, it is necessary to encode each slice video to obtain a plurality of encoded slice videos, and then store the plurality of encoded slice videos in a video database, so that the slice video stream can be determined from the plurality of encoded slice videos, thereby ensuring that no decoding errors occur when the slice video streams are stitched together later, and that the merged slice video streams can still be decoded normally.

In one implementation, the inter-frame predictive coding operation is improved, as shown in FIG. 9, and S305 may include:
S401: Determining a search range corresponding to each slice video.

In some implementations of the present disclosure, the server can determine the search range corresponding to each coding block for each slice video based on the size of the slice video and the position of the coding block in the slice video. In some implementations, the server can also determine the search range corresponding to the current coding block based on the coordinates of the current coding block, the width of the current coding block, and the height of the current coding block, taking into account the possible image edge errors caused by sub-pixel interpolation. The implementations of the present disclosure do not limit the specific implementation of determining the search range. The search range refers to the search range corresponding to each coding block in the slice video.

It should be noted that the purpose of setting the search range corresponding to each coding block in some implementations of the present disclosure is to ensure that the reference block found is located within the same slice video, and cannot cross other slice videos or use pixels from other slice videos, so as to ensure the relative independence between slice videos, thereby ensuring that no decoding errors occur when the slice video streams are stitched together later.
S402: Performing motion search in each search range, to obtain a motion vector corresponding to each search range.

In some implementations of the present disclosure, the server can perform motion search for each coding block within the corresponding search range of each coding block, to obtain a motion vector (MV) corresponding to each search range. It should be noted that the current coding block can only be searched within the search range where the coding block is located during motion search, and if the search result involves sub-pixels, since sub-pixels are calculated from integer pixels, it is also necessary to ensure that the pixels for calculating these sub-pixels are also within the search range, so as to ensure the relative independence between slice videos.
S403: Encoding each slice video based on the motion vector corresponding to each search range, to obtain a plurality of encoded slice videos.

In some implementations of the present disclosure, for each slice video, the server can calculate the pixel residual based on the motion vector corresponding to each search range, perform DCT (Discrete Cosine Transform) and quantization on the pixel residual, and then perform entropy coding on the processed slice video to obtain a plurality of encoded slice videos.

In this implementation, in order to ensure that a plurality of slice video streams can be merged into one video stream, it is necessary to set the search range corresponding to each coding block when encoding each slice video, to limit the search range of inter-frame predictive coding, so as to ensure the relative independence between slice videos, and ensure that the motion vector in each determined slice video cannot exceed the range of the current slice video, thereby ensuring that no decoding errors occur when the slice video streams are stitched together later, and that the merged slice video streams can still be decoded normally.

In some implementations, S401 may include:
for each slice video, determining a search range corresponding to each coding block based on a size of the slice video and a position of the coding block in the slice video.

In some implementations of the present disclosure, for each slice video, the server can acquire the position of each coding block in each slice video, and determine the search range corresponding to each coding block based on the size of the slice video and the position of each coding block in the slice video. For example, suppose the slice video is a rectangle with both length and width n, and the coordinate position of the current coding block in the slice video is (x, y)=(1, 1), then the search range corresponding to the current coding block can be determined as −1<=x<=n−1, −1<=y<=n−1 to cover the length n and the width n.

In this implementation, for each slice video, by accurately determining the search range corresponding to each coding block based on the size of the slice video and the position of the coding block in the slice video, the search range of inter-frame predictive coding can be accurately limited, so as to ensure the relative independence between slice videos, and ensure that the motion vector in each determined slice video cannot exceed the range of the current slice video, thereby ensuring that no decoding errors occur when the slice video streams are stitched together later, and that the merged slice video streams can still be decoded normally.

In some aspects, as shown in FIG. 10, some implementations for segmenting the panoramic video are provided. For instance, when the server executes operation S304 “segmenting the panoramic video into a plurality of slice videos,” it may include:
S501: Generating a corresponding cubic unfolded image based on the panoramic video.

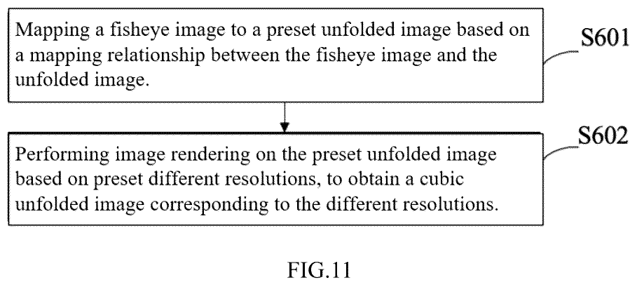

The panoramic video may include but is not limited to a panoramic image or a fisheye image. The cubic unfolded image (cubemap) is a graphic in which each face of the cube is unfolded and tiled on a plane. In some implementations of the present disclosure, in some implementations, if the panoramic video is a panoramic image captured by a panoramic camera, the server can generate a corresponding cubic unfolded image based on the panoramic image. In some implementations, if the panoramic video is a fisheye image captured by a fisheye camera, the server can generate a corresponding cubic unfolded image based on the fisheye image. The implementations of the present disclosure do not limit the specific implementation of generating the cubic unfolded image. It should be noted that the implementations of the present disclosure improve the operation of generating the cubic unfolded image based on the fisheye image, and the specific operation of generating the cubic unfolded image based on the fisheye image can be found in some implementations corresponding to FIG. 11 below.
S502: Segmenting the cubic unfolded image based on a segmentation requirement, to obtain a plurality of slice videos.

In some implementations of the present disclosure, the server can segment the cubic unfolded image based on a segmentation requirement, to obtain a plurality of slice videos. The segmentation requirement may include preset segmentation size, preset segmentation shape, etc., and the implementations of the present disclosure do not limit the segmentation requirement. For example, if the segmentation requirement requires the slice to be a rectangle with width W and height H, and the size of the overlapping region between adjacent slices is O, then the coordinates of the upper left vertex of the slice video in the y-th row and x-th column after segmentation in the cubic unfolded image are (x*(W−O), y*(H−O)).

In this implementation, the corresponding cubic unfolded image can be generated based on the panoramic video, and then the cubic unfolded image can be segmented based on the segmentation requirement to obtain a plurality of slice videos, so that the pixel density of the plurality of slice videos can be more uniform.

In one implementation, as shown in FIG. 11, when the panoramic video is a fisheye image captured by a fisheye camera, S501 may include:
S601: Mapping a fisheye image to a preset unfolded image based on a mapping relationship between the fisheye image and the unfolded image.

In some implementations of the present disclosure, for each pixel in the unfolded image, the server can first project each pixel in the unfolded image onto a unit sphere according to the cubemap projection relationship, to obtain the three-dimensional point corresponding to each pixel in the unfolded image on the unit sphere, and then project the three-dimensional point corresponding to each pixel onto the fisheye image according to the fisheye calibration information, to obtain the corresponding point of each pixel on the fisheye image, so as to obtain the mapping relationship between the fisheye image and the unfolded image. In addition, a seamless stitching algorithm can also be used to adjust the obtained mapping relationship, so that the images at the stitching seams are aligned, ghosting and discontinuities are eliminated, and the cubemap unfolded image has a seamless stitching effect. The mapping relationship between the fisheye image and the unfolded image can be in the form of a graph or table, and the implementations of the present disclosure do not limit the specific form of the mapping relationship between the fisheye image and the unfolded image. Then, the server can map the fisheye image captured by the fisheye camera to the preset unfolded image based on the mapping relationship between the fisheye image and the unfolded image. The preset unfolded image refers to a cubemap unfolded image that only includes position information and does not contain color information.
S602: Performing image rendering on the preset unfolded image based on preset different resolutions, to obtain a cubic unfolded image corresponding to the different resolutions.

In some implementations of the present disclosure, the server can perform image rendering on the preset unfolded image based on preset different resolutions, to obtain a cubic unfolded image corresponding to the different resolutions. In some implementations, the server can perform different image rendering on the preset unfolded image based on the preset different resolutions, to obtain a cubic unfolded image corresponding to the different resolutions. In some implementations, the server can first perform image rendering on the preset unfolded image based on the maximum resolution among the preset different resolutions, to generate a cubic unfolded image corresponding to the maximum resolution, and then perform downsampling on the cubic unfolded image corresponding to the maximum resolution based on the other resolutions among the preset different resolutions, to obtain a cubic unfolded image corresponding to the other resolutions. The implementations of the present disclosure do not limit the specific implementation of generating the cubic unfolded image. For the stitching region, image fusion operations are also required during the image rendering process, and the implementations of the present disclosure do not limit the specific implementation of image fusion.

It should be noted that the present disclosure can also implement the extension process of the cubemap face. Specifically, each unfolded cubemap face of the cubic unfolded image has an extra part of the image around each unfolded cubemap face compared to the actual cubemap face, and the content of the extra part is the same as the edge content of the adjacent cubemap face. When rendering the edge pixels of the cubemap face, the above extended image content can be sampled within the same cubemap face, without cross-cubemap sampling (i.e., sampling from multiple cubemap faces), so as to facilitate the rendering sampling of edge pixels.

In this implementation, the server can map the fisheye image to the preset unfolded image based on the mapping relationship between the fisheye image and the unfolded image, and the server can perform image rendering on the preset unfolded image based on preset different resolutions, to obtain a cubic unfolded image corresponding to the different resolutions. In this way, the server can comprehensively consider the processing cost, bandwidth, and client image quality experience of the panoramic video, and determine the most suitable resolution for each layer, so as to generate a cubic unfolded image corresponding to different resolutions based on the most suitable resolution for each layer.

In some implementations, S602 may include:
performing image rendering on the preset unfolded image based on a maximum resolution in the preset different resolutions, to obtain a cubic unfolded image corresponding to the maximum resolution.

Performing downsampling on the unfolded image corresponding to the maximum resolution based on other resolutions in the different resolutions, to obtain a cubic unfolded image corresponding to the other resolutions.

In some implementations of the present disclosure, the server can pre-set the number of pyramid layers and the preset different resolutions. The setting principles of the number of pyramid layers and the preset different resolutions may include but are not limited to: first, when image rendering is performed in the rendering window at any field of view angle allowed by the client, a suitable resolution level can be selected from the multiple layers of the pyramid to ensure the visual quality of the rendered image and the required bandwidth is optimal at the current resolution level; second, the storage and transcoding cost and the rendering performance of the client need to be comprehensively considered to determine the number of pyramid layers and the different resolutions corresponding to each layer. Each different resolution corresponds to a layer of the pyramid. Then, the server can determine the maximum resolution among the preset different resolutions, and perform image rendering on the preset unfolded image based on the maximum resolution among the preset different resolutions, to generate a cubic unfolded image corresponding to the maximum resolution, and then perform downsampling on the cubic unfolded image corresponding to the maximum resolution based on the other resolutions among the preset different resolutions, to obtain a cubic unfolded image corresponding to the other resolutions, so as to generate a cubic unfolded image corresponding to different resolutions.

In this implementation, the server can perform image rendering on the preset unfolded image based on the maximum resolution among the preset different resolutions, to obtain a cubic unfolded image corresponding to the maximum resolution, and can perform downsampling on the unfolded image corresponding to the maximum resolution based on the other resolutions among the different resolutions, to obtain a cubic unfolded image corresponding to the other resolutions. In this way, the server can comprehensively consider the processing cost, bandwidth, and client image quality experience of the panoramic video, and determine the most suitable resolution for each layer, so as to generate a cubic unfolded image corresponding to different resolutions based on the most suitable resolution for each layer.

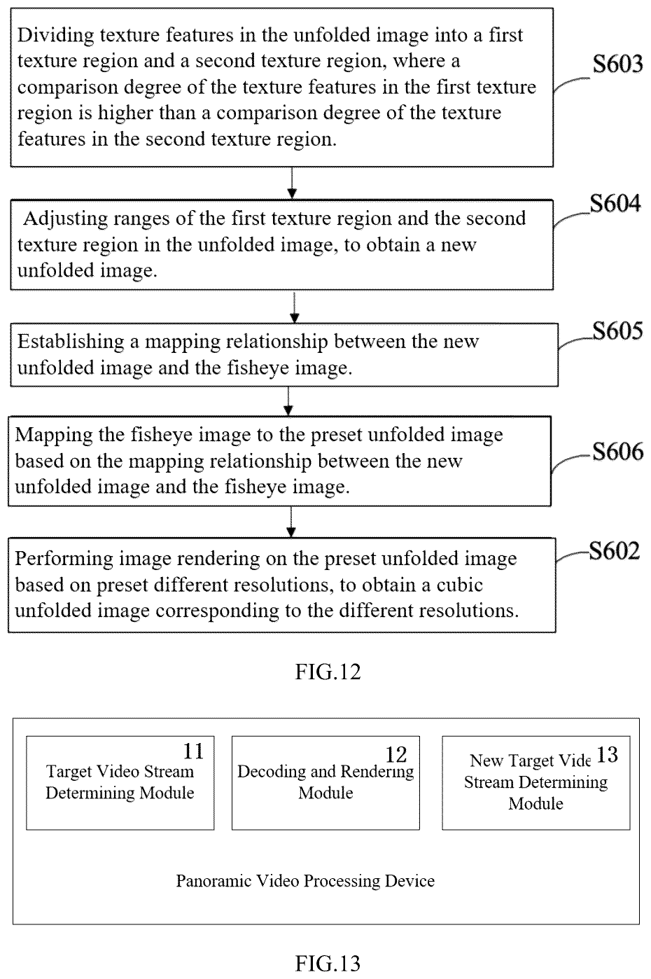

In one implementation, as shown in FIG. 12, the above panoramic video processing method may further include:
S603: Dividing texture features in an unfolded image into a first texture region and a second texture region, where a comparison degree of the texture features in the first texture region is higher than a comparison degree of the texture features in the second texture region.

In some implementations of the present disclosure, the server can pre-quantify the texture richness of the unfolded image, and divide the texture features in the unfolded image into a first texture region and a second texture region based on the quantified texture richness of the unfolded image. For example, the server can compare the texture features of each pixel in the unfolded image with a preset texture threshold. If the texture feature of a pixel in the unfolded image is greater than or equal to the preset texture threshold, the pixel can be divided into the first texture region; and if the texture feature of a pixel in the unfolded image is less than the preset texture threshold, the pixel can be divided into the second texture region. In some implementations, the shapes of the first texture region and the second texture region can be regular square grids, or irregular polygonal grids, and the implementations of the present disclosure do not limit the shapes of the first texture region and the second texture region. The comparison degree of the texture features in the first texture region is higher than the comparison degree of the texture features in the second texture region. For instance, the texture richness in the first texture region is higher than that in the second texture region. The method for quantifying the texture richness of the image may include but is not limited to image gradient calculation, edge detection, saliency detection, etc. In addition, in some implementations, the division of texture regions can be performed on the original fisheye image, or on the unfolded image, and the implementations of the present disclosure do not limit this.
S604: Adjusting ranges of the first texture region and the second texture region in the unfolded image, to obtain a new unfolded image.

In some implementations of the present disclosure, the server can obtain a new unfolded image by adjusting the range or area of the first texture region and the second texture region in the unfolded image. For example, the server can expand the range of the first texture region according to a first scaling ratio, and reduce the range of the second texture region according to a second scaling ratio, so as to obtain a new unfolded image. In some implementations, the reciprocals of the first scaling ratio and the second scaling ratio can be equal, or the reciprocals of the first scaling ratio and the second scaling ratio can also be unequal. The implementations of the present disclosure do not limit the specific values of the first scaling ratio and the second scaling ratio.
S605: Establishing a mapping relationship between the new unfolded image and the fisheye image.

Operation S601 may include:
S606: Mapping the fisheye image to the preset unfolded image based on the mapping relationship between the new unfolded image and the fisheye image.

In some implementations of the present disclosure, for each pixel in the new unfolded image, the server can first project each pixel in the new unfolded image onto a unit sphere according to the cubemap projection relationship, to obtain the three-dimensional point corresponding to each pixel in the new unfolded image on the unit sphere, and then project the three-dimensional point corresponding to each pixel onto the fisheye image according to the fisheye calibration information, to obtain the corresponding point of each pixel on the fisheye image, so as to obtain the mapping relationship between the fisheye image and the new unfolded image. The mapping relationship between the fisheye image and the new unfolded image can be in the form of a graph or table, and the implementations of the present disclosure do not limit the specific form of the mapping relationship between the fisheye image and the new unfolded image. Then, the server can map the fisheye image captured by the fisheye camera to the preset unfolded image based on the mapping relationship between the fisheye image and the new unfolded image.

In this implementation, by dividing the texture features in the unfolded image into a first texture region and a second texture region, and adjusting the range of the first texture region and the second texture region in the unfolded image to obtain a new unfolded image, the proportion of the image region in the unfolded image can be redistributed according to the texture richness of the image, so that the visual quality of the texture-rich region (i.e., the first texture region) can be improved without changing the resolution of the unfolded image.

In some implementations, operation S604 may include:
expanding the range of the first texture region and reducing the range of the second texture region, to obtain the new unfolded image, where a first range in the new unfolded image is equal to a second range in the unfolded image, and the first range is a sum of the ranges of the first texture region and the second texture region in the new unfolded image, and the second range is a sum of the ranges of the first texture region and the second texture region in the unfolded image.

In some implementations of the present disclosure, the server can expand the range of the first texture region to obtain a new range of the first texture region, and reduce the range of the second texture region to obtain a new range of the second texture region. In addition, it is also necessary to ensure that the first range in the new unfolded image is equal to the second range in the unfolded image, and the content in the original first texture region is directly enlarged to the new first texture region, and the content in the original second texture region is directly reduced to the new second texture region, so as to obtain the new unfolded image. The first range is the sum of the ranges of the first texture region and the second texture region in the new unfolded image, and the second range is the sum of the ranges of the first texture region and the second texture region in the unfolded image. For instance, when adjusting the range of the first texture region and the second texture region in the unfolded image, it is necessary to ensure that the sum of the range of the new first texture region and the new second texture region is equal to the sum of the range of the first texture region and the second texture region in the unfolded image.

In this implementation, by expanding the range of the first texture region and reducing the range of the second texture region, a new unfolded image can be obtained. For instance, the visual quality of the texture-rich region (i.e., the first texture region) can be improved without changing the resolution of the unfolded image.

In one implementation, a panoramic video processing system is provided, including a camera end, a client, and a server.

The camera end is configured to send a captured panoramic video to the server.

The server is configured to segment the panoramic video into a plurality of slice videos, store the plurality of slice videos, and generate a video slice index corresponding to each slice video.

The server is further configured to generate a low-resolution bitstream of the panoramic video as a background bitstream based on the panoramic video.

The client can be configured to determine a current viewing region of a user, determine a corresponding video slice index based on the viewing region, and send the video slice index to the server.

The server is further configured to send a corresponding slice video stream and a background bitstream to the client based on the video slice index, and accordingly, the client can display the background bitstream during a process of switching to a new slice video stream.

In some implementations of the present disclosure, the panoramic video processing system includes a camera end, a client, and a server, where the camera end is used to capture the panoramic video, the server may include but is not limited to the cloud, and the client is the playback terminal. Data transmission can be performed between the camera end, the client, and the server. The camera end can be configured to capture the panoramic video and send the captured panoramic video to the server. The server can segment the received panoramic video into a plurality of slice videos and store the plurality of slice videos. In addition, the server can generate a video slice index corresponding to each slice video and store the video slice index together with the corresponding slice video. The server can also generate a low-resolution bitstream of the panoramic video based on the high-definition panoramic video and store the low-resolution bitstream of the panoramic video as the background bitstream.

When the user needs to watch the panoramic video, the client can determine the user's current viewing region, and based on the viewing region, determine the video slice index corresponding to the viewing region from the indices of the multiple slice videos in the panoramic video, and send the video slice index to the server. Thus, the server can determine the slice video stream corresponding to the video slice index based on the received video slice index, and send the slice video stream and the pre-stored background bitstream to the client. Then, the client can decode and render the received slice video stream to the viewing region, and when the client detects that the viewing region of the user changes, it can determine the new video slice index corresponding to the changed viewing region, and pull the corresponding new slice video stream based on the new video slice index, and display the background bitstream during a process of switching to the new slice video stream, so as to improve the effect of the user watching the panoramic video.

In the above panoramic video processing system, the panoramic video processing system includes a camera end, a client, and a server; the camera end is configured to send a captured panoramic video to the server; the server is configured to segment the panoramic video into a plurality of slice videos, store the plurality of slice videos, and generate a video slice index corresponding to each slice video; the server is further configured to generate a low-resolution bitstream of the panoramic video as a background bitstream based on the panoramic video; the client is configured to determine a current viewing region of a user, determine a corresponding video slice index based on the viewing region, and send the video slice index to the server; the server is further configured to send a corresponding slice video stream and a background bitstream to the client based on the video slice index, so that the client displays the background bitstream during a process of switching to a new slice video stream. By performing data transmission between the camera end, the client, and the server, when the user needs to watch the panoramic video, the client only needs to receive and process the slice video stream corresponding to the viewing region and the background bitstream, without transmitting and processing the entire panoramic video, which can greatly reduce the network bandwidth in the transmission and processing of panoramic video, and does not affect the effect of the user watching the slice video, thereby ensuring smooth and efficient transmission and visual quality of panoramic video under low bandwidth. In addition, since the client can receive the background bitstream, the client can display the background bitstream during a process of switching to a new slice video stream, so as to improve the effect of the user watching the panoramic video.

It should be understood that although the operations in the flowcharts of the above implementations are shown sequentially according to the arrows, these operations are not necessarily executed in the order indicated by the arrows. Unless otherwise specified herein, the execution of these operations is not strictly limited in order, and these operations may be executed in other orders. Moreover, at least some of the operations in the flowcharts of the above implementations may include multiple operations or multiple stages, and these operations or stages are not necessarily completed at the same time, but may be executed at different times, and the execution order of these operations or stages is not necessarily sequential, but may be alternately or interleaved with at least part of other operations or operations or stages in other operations.

Based on the same creative concept, the implementations of the present disclosure also provide a panoramic video processing device for implementing the panoramic video processing method described above. The implementation scheme provided by the device for solving the problem is similar to the implementation scheme described in the above method, so the specific limitations in one or more implementations of the panoramic video processing device provided below can be referred to the above limitations of the panoramic video processing method, which will not be repeated here.

In an exemplary implementation, as shown in FIG. 13, a panoramic video processing device is provided, including: a target video stream determining module 11, a decoding and rendering module 12, and a new target video stream determining module 13, applied to a client, where:
the target video stream determining module 11 is configured to determine a current viewing region of a user, and acquire a corresponding target video stream based on the viewing region.

The decoding and rendering module 12 is configured to decode and render the target video stream to the viewing region.

The new target video stream determining module 13 is configured to, when it is detected that the viewing region of the user changes, determine a new target video stream corresponding to the changed viewing region, and display a background bitstream during a process of switching to the new target video stream, where the background bitstream is a low-resolution bitstream of the panoramic video.

In one implementation, the above panoramic video processing device further includes:
a display module, configured to, when it is detected that a display cannot normally display the target video stream, display the background bitstream.

In one implementation, the display module includes:
a display unit, configured to, when the target video stream cannot be pulled from a server in time, display the background bitstream on the display.

In one implementation, the target video stream determining module 11 includes:
a first determining sub-module, configured to determine a current viewing region of a user, and determine a corresponding video slice index based on the viewing region, where the video slice index is an index of a slice video in the panoramic video; and
an acquiring sub-module, configured to acquire a corresponding slice video stream based on the video slice index, where the slice video stream is the target video stream;

The new target video stream determining module 13 includes:
a second determining sub-module, configured to, when it is detected that the viewing region of the user changes, determine a new video slice index corresponding to the changed viewing region, and pull a corresponding new slice video stream based on the new video slice index, and display the background bitstream during a process of switching to the new slice video stream.

In one implementation, the acquiring sub-module includes:
a sending unit, configured to send the video slice index to a server, so that the server determines a slice video stream to be sent based on the video slice index; and
a receiving unit, configured to receive the slice video stream sent by the server.

In one implementation, different resolution slice videos are stored on the server for the same slice.

The video slice index includes a layer index and a slice index of the same layer, different layers correspond to different resolutions, and the same layer corresponds to the same resolution.

In one implementation, different resolution slice videos are stored on the server for the same slice.

The above panoramic video processing device further includes:
a field of view angle size determining module, configured to determine a size of a field of view angle corresponding to the viewing region;
a target resolution determining module, configured to determine a corresponding target resolution based on the size of the field of view angle and/or a current network bandwidth condition of the client; and
the acquiring sub-module including:
a first receiving unit, configured to receive a slice video stream sent by the server based on the video slice index and the target resolution.

In one implementation, different resolution slice videos are stored on the server for the same slice, including:
the server determines a search range corresponding to each slice video;
the server performs motion search in each search range, to obtain a motion vector corresponding to each search range; and
the server encodes each slice video based on the motion vector corresponding to each search range, to obtain a plurality of encoded slice videos; and
the server stores the plurality of encoded slice videos.

In one implementation, the panoramic video is a fisheye image captured by a fisheye camera; and different resolution slice videos are stored on the server for the same slice, including:
the server maps the fisheye image to a preset unfolded image based on a mapping relationship between the fisheye image and the unfolded image;
the server performs image rendering on the preset unfolded image based on preset different resolutions, to obtain a cubic unfolded image corresponding to the different resolutions; and
the server segments the cubic unfolded image based on a segmentation requirement, to obtain a plurality of slice videos.

In one implementation, different resolution slice videos are stored on the server for the same slice.

The above panoramic video processing device further includes:
a slice video stream determining module, configured to determine a size of a field of view angle corresponding to the viewing region, and send the size of the field of view angle to the server, so that the server determines a corresponding target resolution based on the size of the field of view angle and/or a current network bandwidth condition of the client, and determines a slice video stream to be sent based on the video slice index and the target resolution.

In one implementation, the first sending module includes:
a video slice index determining unit, configured to determine the video slice index based on a position of a projection of each pixel in the viewing region on the panoramic video.

In one implementation, the video slice index determining unit includes:
a rendering window determining sub-unit, configured to determine a rendering window based on a view angle parameter of a current rendered image corresponding to the viewing region;
a target pixel determining sub-unit, configured to determine a target pixel falling in the rendering window on a cubic unfolded image corresponding to the panoramic video; and
a video slice index determining sub-unit, configured to determine the video slice index based on the target pixel.

In one implementation, the target pixel determining sub-unit includes:
a mask image generating sub-unit, configured to project each pixel in the cubic unfolded image onto a plane where the rendering window is located, to obtain a mask image corresponding to the cubic unfolded image, where a gray value of a pixel contained in the rendering window in the mask image is a first value, and a gray value of a pixel contained in another region in the mask image is a second value; and
a target pixel selecting sub-unit, configured to determine the target pixel falling in the rendering window on the cubic unfolded image based on the mask image.

In one implementation, the mask image generating sub-unit includes:
a projected pixel generating sub-unit, configured to project each pixel in the cubic unfolded image onto a plane where the rendering window is located, to obtain projected pixels; and
a mask image obtaining sub-unit, configured to set a gray value of a pixel located in the rendering window to the first value, and set a gray value of another pixel to the second value, to obtain the mask image.

In one implementation, the decoding and rendering module includes:
a merging unit, configured to merge the slice video stream to obtain a merged video stream;
a decoding unit, configured to decode the merged video stream to obtain decoded frame data; and
a rendering unit, configured to upload the decoded frame data to a renderer, and determine a position of each pixel in the viewing region on the decoded frame data by the renderer, to render the decoded frame data to the viewing region.

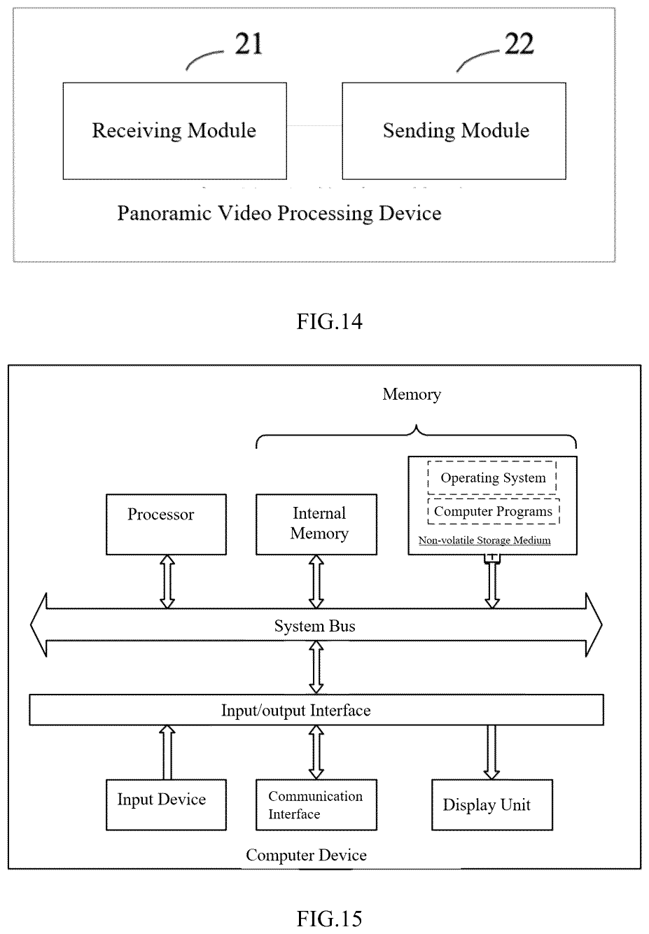

In an exemplary implementation, as shown in FIG. 14, a panoramic video processing device is provided, including: a receiving module 21 and a sending module 22, applied to a server, where:
the receiving module 21 is configured to receive a video slice index sent by a client, where the video slice index is determined based on a current viewing region of a user, and the video slice index is an index of a slice video in a panoramic video.

The sending module 22 is configured to send a corresponding slice video stream and a background bitstream to the client based on the video slice index, where the background bitstream is a low-resolution bitstream of the panoramic video, so that the client displays the background bitstream during a process of switching to a new slice video stream.

In one implementation, the above panoramic video processing device further includes:
a panoramic video acquiring module, configured to receive an uploaded panoramic video; and
a segmentation module, configured to segment the panoramic video into a plurality of slice videos, and store the plurality of slice videos.

In one implementation, the above panoramic video processing device further includes:
an encoding module, configured to encode each slice video to obtain a plurality of encoded slice videos.

The segmentation module includes:
a storage unit, configured to store the plurality of encoded slice videos in a video database.

In one implementation, the encoding module includes:
a search range determining unit, configured to determine a search range corresponding to each slice video;
a motion search unit, configured to perform motion search in each search range, to obtain a motion vector corresponding to each search range; and
an encoding unit, configured to encode each slice video based on the motion vector corresponding to each search range, to obtain a plurality of encoded slice videos.

In one implementation, the search range determining unit includes:
a search range determining sub-unit, configured to, for each slice video, determine a search range corresponding to each coding block based on a size of the slice video and a position of the coding block in the slice video.

In one implementation, the segmentation module includes:
a cubic unfolded image generating unit, configured to generate a corresponding cubic unfolded image based on the panoramic video; and
a segmentation unit, configured to segment the cubic unfolded image based on a segmentation requirement, to obtain a plurality of slice videos.

In one implementation, the panoramic video is a fisheye image captured by a fisheye camera; the cubic unfolded image generating unit includes:
a mapping sub-unit, configured to map the fisheye image to a preset unfolded image based on a mapping relationship between the fisheye image and the unfolded image; and
a cubic unfolded image generating sub-unit, configured to perform image rendering on the preset unfolded image based on preset different resolutions, to obtain a cubic unfolded image corresponding to the different resolutions.

In one implementation, the cubic unfolded image generating sub-unit includes:
an image rendering sub-unit, configured to perform image rendering on the preset unfolded image based on a maximum resolution in the preset different resolutions, to obtain a cubic unfolded image corresponding to the maximum resolution; and
a downsampling sub-unit, configured to respectively perform downsampling on the unfolded image corresponding to the maximum resolution based on other resolutions in the different resolutions, to obtain a cubic unfolded image corresponding to the other resolutions.

In one implementation, the above panoramic video processing device further includes:
a division module, configured to divide texture features in the unfolded image into a first texture region and a second texture region, where a comparison degree of the texture features in the first texture region is higher than a comparison degree of the texture features in the second texture region;
a new unfolded image generating module, configured to adjust ranges of the first texture region and the second texture region in the unfolded image, to obtain a new unfolded image; and
a new mapping relationship constructing module, configured to establish a mapping relationship between the new unfolded image and the fisheye image.

The mapping sub-unit includes:
a new mapping sub-unit, configured to map the fisheye image to the preset unfolded image based on the mapping relationship between the new unfolded image and the fisheye image.

In one implementation, the new unfolded image generating module includes:
a new unfolded image generating unit, configured to expand the range of the first texture region and reduce the range of the second texture region, to obtain the new unfolded image, where a first range in the new unfolded image is equal to a second range in the unfolded image, and the first range is a sum of the ranges of the first texture region and the second texture region in the new unfolded image, and the second range is a sum of the ranges of the first texture region and the second texture region in the unfolded image.

The modules in the above panoramic video processing device can be implemented entirely or partially by software, hardware, or a combination thereof. The above modules may be embedded in or independent of the processor of the computer device in hardware form, or may be stored in the memory of the computer device in software form. As such, the processor can call and execute the operations corresponding to the above modules.

In an exemplary implementation, a computer device is provided, which may be a client, and its internal structure is shown in FIG. 15. The computer device includes a processor, a memory, an input/output interface, a communication interface, a display unit, and an input device. The processor, memory, and input/output interface are connected via a system bus, and the communication interface, display unit, and input device are connected to the system bus via the input/output interface. The processor of the computer device is used to provide computing and control capabilities. The memory of the computer device includes non-volatile storage media and internal memory. The non-volatile storage media stores the operating system and computer programs. The internal memory provides an environment for running the operating system and computer programs in the non-volatile storage media. The input/output interface of the computer device is used for exchanging information between the processor and external devices. The communication interface of the computer device is used to communicate with external clients in a wired or wireless manner, and the wireless manner can be implemented by WIFI, mobile cellular network, NFC (Near Field Communication), or other technologies. The computer program is executed by the processor to implement a panoramic video processing method. The display unit of the computer device is used to form a visually visible picture, and may be a display screen, a projection device, or a virtual reality imaging device. The display screen may be a liquid crystal display or an electronic ink display. The input device of the computer device may be a touch layer covering the display screen, or keys, a trackball, or a touchpad provided on the housing of the computer device, or an external keyboard, touchpad, or mouse, etc.

Those skilled in the art can understand that the structure shown in FIG. 15 is only a block diagram of the relevant part of the present disclosure scheme and does not constitute a limitation on the computer device to which the present disclosure scheme is applied. The specific computer device may include more or fewer components than those shown in the figure, or combine certain components, or have different component arrangements.

In one implementation, a computer device is provided, including a memory and a processor, where the memory stores a computer program, and when the processor executes the computer program, the operations of the above method implementations are implemented.

In one implementation, a computer-readable storage medium is provided, on which a computer program is stored, and when the computer program is executed by a processor, the operations of the above method implementations are implemented.

In one implementation, a computer program product is provided, including a computer program, and when the computer program is executed by a processor, the operations of the above method implementations are implemented.

It should be noted that the user information (including but not limited to user device information, user personal information, etc.) and data (including but not limited to data for analysis, stored data, displayed data, etc.) involved in the present disclosure are all information and data authorized by the user or fully authorized by all parties, and the collection, use, and processing of relevant data need to comply with relevant regulations.

Those of ordinary skill in the art can understand that all or part of the processes in the above method implementations can be completed by instructing related hardware through a computer program, and the computer program can be stored in a non-volatile computer-readable storage medium. When the computer program is executed, it may include the processes of the method implementations described above. Any reference to memory, database, or other media used in some implementations of the present disclosure may include at least one of non-volatile and volatile memory. Non-volatile memory may include Read-Only Memory (ROM), magnetic tape, floppy disk, flash memory, optical storage, high-density embedded non-volatile memory, resistive RAM (ReRAM), Magnetoresistive RAM (MRAM), ferroelectric RAM (FRAM), phase-change memory (PCM), graphene memory, etc. Volatile memory may include Random Access Memory (RAM) or external high-speed cache, etc. By way of illustration and not limitation, RAM may be in various forms, such as Static Random Access Memory (SRAM) or Dynamic Random Access Memory (DRAM), etc. The database involved in some implementations of the present disclosure may include at least one of relational and non-relational databases. Non-relational databases may include blockchain-based distributed databases, etc., but are not limited thereto. The processor involved in some implementations of the present disclosure may be a general-purpose processor, central processor, graphics processor, digital signal processor, programmable logic device, quantum computing-based data processing logic, etc., but is not limited thereto.

The technical features of the above implementations can be combined arbitrarily. For the sake of brevity, not all possible combinations of the technical features in the above implementations are described, but as long as there is no contradiction in the combination of these technical features, they should be regarded as within the scope described in this specification.

The above implementations only express several implementation modes of the present disclosure, and the description is relatively specific and detailed, but should not be understood as limiting the scope of the present disclosure. It should be pointed out that, for those of ordinary skill in the art, several modifications and improvements can be made without departing from the concept of the present disclosure, and these all belong to the protection scope of the present disclosure. Therefore, the protection scope of the present disclosure should be subject to the appended claims.

What is claimed is:

1. A processing method for a panoramic video, applied to a client, comprising:
determining a current viewing region of a user on a display, and acquiring a corresponding target video stream based on the current viewing region;
decoding and rendering the target video stream to the current viewing region on the display; and
in response to detecting that the current viewing region of the user on the display changes to be a changed viewing region, determining a new target video stream corresponding to the changed viewing region, and displaying a background bitstream on the display during a process of switching the target video stream to the new target video stream, wherein the background bitstream comprises a low-resolution bitstream of the panoramic video.

2. The method according to claim 1, further comprising:
in response to detecting that the display fails to display the target video stream, displaying the background bitstream on the display.

3. The method according to claim 2, wherein in response to detecting that the display fails to display the target video stream, displaying the background bitstream comprises:
in response to determining that the target video stream fails to be pulled from a server within a preset time period, displaying the background bitstream on the display.

4. The method according to claim 1, wherein determining the current viewing region of the user on the display, and acquiring the corresponding target video stream based on the current viewing region comprises:
determining the current viewing region of the user on the display, and acquiring a corresponding video slice index based on the current viewing region, wherein the video slice index comprises an index of a slice video of the panoramic video;
acquiring a slice video stream corresponding to the video slice index, wherein the target video stream comprises the slice video stream; and
in response to determining that the current viewing region of the user changes to be the changed viewing region, determining the new target video stream corresponding to the changed viewing region, and displaying the background bitstream on the display during the process of switching the target video stream to the new target video stream, comprising:
in response to determining that the current viewing region of the user changes, determining a new video slice index corresponding to the changed viewing region, and pulling a corresponding new slice video stream based on the new video slice index, and displaying the background bitstream on the display during the process of switching the slice video stream to the new slice video stream.

5. The method according to claim 4, wherein acquiring the slice video stream corresponding to the video slice index comprises:
sending the video slice index to a server, the server being configured to determine the slice video stream to be sent based on the video slice index; and
receiving the slice video stream sent by the server.

6. The method according to claim 5, wherein:
the server is configured to store slice videos at different resolutions for a same slice; and
the video slice index comprises a layer index and a slice index of a same layer, wherein each layer corresponds to a distinct resolution, and slices within a same layer share a same resolution.

7. The method according to claim 5, wherein:
the server is configured to store slice videos at different resolutions for a same slice; and
the method further comprises:
determining a size of a field of view corresponding to the current viewing region; and
determining a corresponding target resolution based on at least one of the size of the field of view or a current network bandwidth condition of the client; and
acquiring the slice video stream corresponding to the video slice index comprises:
receiving the slice video stream sent by the server based on the video slice index and the target resolution.

8. The method according to claim 7, wherein:
the panoramic video includes a panoramic image captured by a panoramic camera; and
the method further comprises:
configuring the server to map the panoramic image to a preset unfolded image based on a mapping relationship between the panoramic image and the unfolded image;
configuring the server to render the preset unfolded image based on preset different resolutions, and obtain a cubic unfolded image corresponding to the different resolutions; and
configuring the server to segment the cubic unfolded image based on a segmentation requirement, and obtain a plurality of slice videos.

9. The method according to claim 5, wherein:
the server is configured to store slice videos at different resolutions for a same slice; and
the method further comprises:
determining a size of a field of view corresponding to the current viewing region, and sending the size of the field of view to the server, the server being configured to determine a corresponding target resolution based on at least one of the size of the field of view or a current network bandwidth condition of the client, and determine the slice video stream to be sent based on the video slice index and the target resolution.

10. The method according to claim 4, wherein acquiring the corresponding video slice index based on the current viewing region comprises:
acquiring the video slice index based on a position of a projection of each pixel in the current viewing region on the panoramic video.

11. The method according to claim 1, wherein the target video stream comprises multiple slice video streams, and wherein decoding and rendering the target video stream to the current viewing region comprises:
merging the slice video stream to obtain a merged video stream;
decoding the merged video stream to obtain decoded frame data; and
uploading the decoded frame data to a renderer, and determining a position of each pixel in the current viewing region on the decoded frame data by the renderer, to render the decoded frame data to the current viewing region.

12. A processing method for a panoramic video, applied to a server, comprising:
receiving a video slice index sent by a client, wherein the video slice index is acquired based on a current viewing region of a user, and the video slice index comprises an index of a slice video of the panoramic video; and
sending a corresponding slice video stream and a background bitstream to the client based on the video slice index, wherein the background bitstream comprises a low-resolution bitstream of the panoramic video, the client being configured to display the background bitstream on the display during a process of switching the slice video stream to a new slice video stream.

13. The method according to claim 12, further comprising:
receiving an uploaded panoramic video; and
segmenting the panoramic video into a plurality of slice videos, and storing the plurality of slice videos.

14. The method according to claim 13, further comprises:
encoding each slice video of the plurality of slice videos to obtain a plurality of encoded slice videos, wherein storing the plurality of slice videos comprises storing the plurality of encoded slice videos in a video database.

15. The method according to claim 14, wherein encoding each slice video to obtain the plurality of encoded slice videos comprises:
determining a search range corresponding to each slice video;
performing motion search in each search range, to obtain a motion vector corresponding to each search range; and
encoding each slice video based on the motion vector corresponding to each search range, to obtain the plurality of encoded slice videos.

16. The method according to claim 13, wherein the segmenting the panoramic video into the plurality of slice videos comprises:
generating a corresponding cubic unfolded image based on the panoramic video; and
segmenting the cubic unfolded image based on a segmentation requirement, to obtain the plurality of slice videos.

17. The method according to claim 16, wherein the panoramic video comprises a panoramic image captured by a panoramic camera, and generating the corresponding cubic unfolded image based on the panoramic video comprises:
mapping the panoramic image to a preset unfolded image based on a mapping relationship between panoramic images and unfolded images; and
performing image rendering on the preset unfolded image based on preset different resolutions, to obtain the cubic unfolded image corresponding to the preset different resolutions.

18. The method according to claim 17, wherein performing image rendering on the preset unfolded image based on the preset different resolutions, to obtain the cubic unfolded image corresponding to the preset different resolutions comprises:
performing image rendering on the preset unfolded image based on a maximum resolution in the preset different resolutions, to obtain a cubic unfolded image corresponding to the maximum resolution; and
respectively performing downsampling on the cubic unfolded image corresponding to the maximum resolution based on remaining resolutions in the different resolutions, to obtain a cubic unfolded image corresponding to the remaining resolutions.

19. The method according to claim 18, further comprising:
dividing texture features in the preset unfolded image into a first texture region and a second texture region, wherein a comparison degree of the texture features in the first texture region is higher than a comparison degree of the texture features in the second texture region; and
adjusting ranges of the first texture region and the second texture region in the preset unfolded image, to obtain a new unfolded image; and
establishing a mapping relationship between the new unfolded image and the panoramic image;
wherein mapping the panoramic image to the preset unfolded image based on the mapping relationship between the panoramic images and the unfolded images comprises:
mapping the panoramic image to the preset unfolded image based on the mapping relationship between the new unfolded image and the panoramic image.

20. A processing system for a panoramic video, comprising:
one or more video cameras configured to capture a panoramic video;
a processor and a memory configured to perform a process, the process comprising:
segmenting the panoramic video into a plurality of slice videos, store the plurality of slice videos, and generate a video slice index corresponding to each slice video of the plurality of slice videos;
generating a low-resolution bitstream of the panoramic video as a background bitstream based on the panoramic video;
determining a current viewing region of a user, and acquiring a corresponding video slice index based on the current viewing region; and
sending a corresponding slice video stream and the background bitstream to a client based on the video slice index, the client being further configured to display the background bitstream on the display during a process of switching the slice video stream to a new slice video stream.
